(19) United States
(12) Patent Application Publication
(10) Pub. No.: US 2012/0094266 A1
(43) Pub. Date: Apr. 19, 2012

(54) Method for Manipulating Data in the Assessment of an Answer Portfolio

(76) Inventors: Declan Oliver Lynch, London (GB); Anthony Donald Wheeler, Ashford (GB); Alastair Buchan Pollitt, Cambridge (GB); Richard Anthony Kimbell, Guildford (GB); Karim David Derrick, London (GB)

(21) Appl. No.: 13/376,161

(22) PCT Filed: May 26, 2010
(86) PCT No.: PCT/GB10/50865

§ 371 Date: Dec. 2, 2011

(30) Foreign Application Priority Data
Jun. 4, 2009 (GB) 0909539.9

(51) Int. Cl. G09B 7/00

(52) U.S. Cl. 434/362

(57) ABSTRACT

A method for manipulating data in the assessment of an answer portfolio, the method comprising the steps of routing a multiplicity of answer portfolios (7) to a file server (6), each answer portfolio assigned with an identifier (9), the file server (16) having an engine (15) running an algorithm, the algorithm sorting the multiplicity of answer portfolios (7) into pairs of answer portfolios (12;i,j) using the identifiers (9) and routing each pair of answer portfolios (12;i,j) to a defined judge's computer terminal (14) of a multiplicity of judge's computer terminal, the algorithm comprising the steps of receiving data (18) from the judge's computer terminal indicative of which of the answer portfolios (7,i,j) of the pair of answer portfolios (12;i,j) wins over the other of the pair of answer portfolios (12;i,j) the method further comprising the step of the engine running said algorithm using said data, the algorithm comprising a Rasch analysis.

### FIELD OF THE INVENTION

The present invention relates to a method for manipulating data in the assessment of an answer portfolio. The present invention also relates to a method and an analysis tool for facilitating the assessment of assessors.

### BACKGROUND TO THE INVENTION

Assessment of an examination or coursework answer, such as homework or end of unit assessment work, has traditionally been carried out on paper. An examination or coursework question is given to the student. The student produces an examination or coursework answer and submits his answer on paper to a teacher or examining board for assessment. An assessor, such as a teacher or member of an examining board assess the answer and expresses this assessment by writing on the work in ink, traditionally red ink, indicating marks awarded and providing comments relating to how well the student has met the objectives of the question. Where a mark is awarded the assessor will ordinarily indicate this with a tick or a number associated with the number of marks warranted. The number of ticks or marks will be summed to give an overall mark for the answer. The Examiner uses a marking schedule to facilitate the marking process. The marking schedule facilitates consistent marking of each student's answer and between different assessors. The overall mark can then be compared to a chart to give an overall grade or compared to the other students' overall marks to give an overall grade.

More recently, answers are scanned to produce a pixel image of the answer, for example a CCITT Group 4 compressed TIF image. The pixel image of the answer is then sent to an examiner over an intranet. The examiner can then asses the answer and provide his mark directly to the student or to an awarding body. Furthermore, students are assigned questions by teachers on computers and students prepare answers on a computer and submit their answer to the assessor, such as a teacher or awarding body for assessment in a computer readable format.

A student may answer a question using a computer application program, such as Word™, Powerpoint™, Inspirations™ or Flowol™. The answer may be saved in a data file for that application and submitted to the assessor (i.e. handed in) in that form. Alternatively, a coursework answer may be printed and submitted on paper of various sizes. But in so doing, some of the benefit of using a computer to generate this coursework will be lost. A Powerpoint™ presentation, when printed out, loses all animation, sound, video and transitions that have been included. When a spreadsheet is printed, for example, it is impossible to see what, if any, formula have been used to calculate specific cells. A coursework answer may utilise any sort of recordable medium to record the coursework, such as on paper, or in computer readable text files, drawing files, spreadsheet files, database files, video files, audio files etc. recorded on to a flash memory stick, a network drive, a local drive, a CD or DVD or the like. In the case of design and technology, art and some other coursework, the coursework answer may be submitted in three-dimensional form.

A problem observed by the present inventors, is that questions require very short answers and/or long questions are presented in the form of a series of questions requiring short answers. This is at least in part, due to the way marking schedules are used. Marking schedules work very well for short answer questions. However, marking schedules become less useful for long answer questions, where the objective nature of marking schedules becomes blurred with subjective long answers.

It is known to sort a multiplicity of hand written answer papers into a series of pairs of answer papers and for a series of assessors to judge each pair and decide which of the pair is a better answer than the other. By carrying out this procedure many times, it is known to create a list of answer papers ranking the best to worst. However, this system is very time consuming and requires all of the assessors to be in one room and to carry out this procedure in one long session, which is impractical. Accordingly, this method of assessment has been confined to small scale class size assessments and has not gained popularity. It is known to use a computer to sort out the pairs for comparison. However, the data processing power required to do this is enormous and has heretoforth been impractical to be carried out on a large scale. The present invention addresses the problems associated with large data handling and manipulating data. Thus, the present invention facilitates a reduction in data flow across a network; a reduction in processing power required of a central processor in deciding which pairs should be judged, in what order and by which judge.

### SUMMARY OF THE INVENTION

In accordance with the present invention, there is provided a method for manipulating data in the assessment of an answer portfolio, the method comprising the steps of routing a multiplicity of answer portfolios to a file server, each answer portfolio assigned with an identifier, the file server having an engine running an algorithm, the algorithm sorting the multiplicity of answer portfolios into pairs of answer portfolios using the identifiers and routing each pair of answer portfolios to a defined judge's computer terminal of a multiplicity of judge's computer terminal, the algorithm comprising the steps of receiving data from the judge's computer terminal indicative of which of the answer portfolios of the pair of answer portfolios wins over the other of the pair of answer portfolios the method further comprising the step of the engine running the algorithm using the data, the algorithm comprising a Rasch analysis. Thus the method of the invention attempts to reduce data flow across the network and reduce the processing power required of a central processor in deciding which pairs should be judged, in what order and by which judge. The answer portfolio may be an answer to an examination question set in an examination environment with an invigilator present or may be the answer to a coursework question.

Preferably, the Rasch analysis checks each answer portfolio against all other answer portfolios of the multiplicity of answer portfolios. Advantageously, a parameter value is calculated for each answer portfolio and used in the selection of pairs of portfolio answers. Advantageously the method further comprises the step of the engine carrying out at least three rounds of a Swiss tournament before the answer paper are subjected to the Rasch analysis and selecting pairs of portfolio answers based on number of wins. Preferably, between four and seven Swiss tournament rounds and most preferably, six rounds. Advantageously, the pairs of portfolio answers are selected by the similar and most preferably the same number of wins, thereby selecting a pair of portfolio answers which have a greater probability of being similar in standard. The Swiss tournament is limited to just a few rounds, such as six rounds. The Swiss Tournament is used as a crude method for calculating the parameter value, which is then refined using the Rasch analysis. The judges have a greater chance of being given very similar standard answers, which makes it difficult to pick a winner. The inventors have observed that a more accurate overall ranking is achieved with fewer rounds by ensuring that portfolio answers are provided in pairs which are of a similar, but not too similar standard. This is achieved, at least in part by using the Rasch analysis to determine a parameter value for each answer portfolio and then using a difference range or value to pair off the answer portfolios. The difference range or value was determined with the aid of the work carried out by Louis Leon Thurstone, disclosed in a paper entitled “The Measurement of Psychological Value” published in a compendium by Thomas Vernor Smith and William Kelley Wright (eds), Essays in Philosophy by Seventeen Doctors of Philosophy of the University of Chicago. Chicago: Open Court (1929): 157-174.

Preferably, each portfolio answer is assigned an initial parameter value (V) calculated using the following equation:

$${V}_{i} = ( {wins}_{i} \times ( \frac{spread}{maxwins} ) ) - ( \frac{spread}{2} )$$

wherein:

“Vi” is the parmeter value for answer portfolio i;

“winsᵢ” is the number of wins for the answer portfolio i;

“spread” is a fixed value for the range of the parameter values; and

“maxwins” is the largest number of wins recorded by an answer portfolio of the multiplicity of answer portfolios

and the parameter value (V) used to select pairs of portfolio answers. This equation is preferably used during the Swiss tournament rounds to determine a parameter value for each answer portfolio.

Advantageously, the Rasch analysis comprises the step of calculating a probability of answer portfolio (i) winning or losing against answer portfolio (j). Preferably, the probability is calculated using the equation:

$$prob ( i , j ) = \frac{exp ( {v}_{i} - {v}_{j} )}{1 + exp ( {v}_{i} - {v}_{j} )}$$

wherein:

“prob(i,j)” is the probability of (i) winning or losing against (j);

“Vi” is the parameter value of (i); and

“Vj” is the parameter value of (j).

Advantageously, the Rasch analysis comprises the step of calculating an adjustment figure (Δᵢ) to adjust the parameter value (V) to calculate on adjusted parameter value. Preferably, the adjustment figure (Δᵢ) is calculated using the equation:

$${Δ}_{i} = \frac{- ( {num}_{i} )}{{denom}_{i}}$$

wherein:
“numᵢ” is calculated using the equation:

$${num}_{i} = {\sum }_{j , j \neq i} {wins}_{ij} - ( {comp}_{ij} \times prob ( i , j ) )$$

“denumᵢ” is calculated using the equation:

$${denom}_{i} = {\sum }_{j , j \neq i} {comp}_{ij} \times prob ( i , j ) \times ( 1 - prob ( i , j ) )$$

“prob(i,j)” is the probability of (i) winning or losing against (j);
“winsᵢⱼ” is the number of times answer portfolio (i) won when compared to the other answer portfolio (j); and
“comp(I,j)” is the number of times answer portfolio (i) was compared to the other answer portfolio (j).

Preferably, the adjusted parameter value (Vi) is calculated by the equation:

Vᵢ=vᵢ−Δᵢ

Advantageously, the algorithm centres all of the adjusted parameter values (V) about an average parameter value (ΔV). Most preferably, the algorithm subtracts the average parameter value (V) from each adjusted parameter value (V) to obtain a value centred around zero and preferably, this spread of values is displayed on a graph to enhance interpretation of the data.

Preferably, the Rasch analysis comprises the step of centring all of the adjusted parameter values (V) about an average parameter value (ΔV) using the equations:

$$\overline{V} = \frac{{\sum }_{n = 1}^{N} {V}_{n}}{N}$$

wherein (N) is the number of portfolio answers in

V_{centre}=Vᵢ− V̅

the multiplicity of portfolio answers; and

preferably, the algorithm calculates a Root Mean Square (RMS) value of the adjustment figures (Δ) using the below equation:

$${Δ}_{rms} = \sqrt{\frac{{\sum }_{n = 1}^{N} {( {Δ}_{n} )}^{2}}{N}}$$

and the algorithm checking the Root Mean Square (RMS) value of the adjustment figure (Δn) relative to a threshold. Preferably, the Rasch analysis stops when the Root Mean Square (RMS) value of the adjustment figure (Δ) is below the threshold which is advantageously, 0.001. Preferably, the Rasch analysis monitors the maximum adjustment figure which has to also be below a threshold, which is advantageously, 0.01, before the Rasch analysis stops.

Preferably, pairs of portfolio answers are selected after the Rasch analysis by selecting portfolio answers which have a parameter value difference of between 1.0 and 0.5, and preferably by 0.8 and 0.6 and most preferably by 0.7. These values have been derived using a methodology compiled by Louis Leon Thurstone.

Advantageously, each portfolio answer forms part of between five and thirty and preferably between twelve and twenty pairs of portfolio answers to be judged.

Preferably, the parameter value for each of the multiplicity of portfolio answers is shown on a graph. Preferably, the graph is dynamic, updating in real time as the judging of pairs of portfolio answers continues. Advantageously, the graph is shown on a visual display unit of a principal moderator or administrator.

Preferably, the engine calculates a standard error for each portfolio answer and displays the standard error on the graph.

Advantageously, the engine carries out the step of calculating a misfit value for each of the portfolio answers, the misfit value calculated by the equations:

$${W}_{i} = {\sum }_{j , j \neq i} prob ( i , j ) \times ( 1 - prob ( i , j ) )$$

$$\text{?} = {\sum }_{j , j \neq i} ( 1 - prob ( i , j ) ) \times prob ( i , j ) \times {( \frac{1 - prob ( i , j )}{\sqrt{( 1 - prob ( i , j ) ) \times prob ( i , j )}} )}^{2}$$

$$\text{?} = \frac{{W}_{i}}{\text{?}}$$

$$\text{?} \text{indicates text missing or illegible when filed}$$

Preferably, the mis-fit value is displayed graphically. Preferably on a graph, with one axis showing the mis-fit value and the other the name of the student.

Advantageously, the engine executes an judgement algorithm to assess quality of the judges by comparing results a judges judgments with the judgements of at least a portion of judgements made by other judges. Preferably, the judgement algorithm calculates a misfit value calculated using the following equations:

$${misfit}_{judge} = ( {WMS ( cube )}_{judge} - 1 ) \times ( ( \frac{3}{{Q}_{judge}} ) + ( \frac{{Q}_{judge}}{3} ) )$$

$${Q}_{judge} = \sqrt{\frac{( \frac{{κ}_{judge}}{{W}_{judge}} )}{{W}_{judge}}}$$

$${WMS ( cube )}_{judge} = \sqrt[3]{\frac{{W}_{judge}}{\text{?}}}$$

$${W}_{judge} = {\sum }_{n = 1}^{N} prob ( i , j ) \times ( 1 - prob ( i , j ) )$$

$$\text{?} {\sum }_{n = 1}^{N} ( 1 - prob ( i , j ) ) \times prob ( i , j ) \times {( \frac{1 - prob ( i , j )}{\sqrt{( 1 - prob ( i , j ) ) \times prob ( i , j )}} )}^{2}$$

$${κ}_{judge} = {\sum }_{n = 1}^{N} ( prob ( i , j ) \times ( 1 - prob ( i , j ) ) \times ( {( prob ( i , j ) )}^{3} + {( 1 - prob ( i , j ) )}^{3} ) ) \cdot {( prob ( i , j ) \times ( 1 - prob ( i , j ) ) )}^{3}$$

$$\text{?} \text{indicates text missing or illegible when filed}$$

Preferably, a student's computer terminal is connected to the internet, the portfolio answer submitted and sent to the file server over the internet. Preferably the portfolio answer is submitted over a secure tunnel or through a virtual private network using the internet.

Advantageously, the portfolio answer is sent to an invigilator's computer for submission to the file server.

Advantageously, the multiplicity of examination answers are each prepared and sent to the file server from a student's computer terminal. The student's computer terminal may be a workstation, a laptop or a mobile communication device. Preferably, the portfolio answer is prepared on the student's computer terminal using a web based application, such as MAPS may be used, and may be accessed through a secure link.

Preferably, the data is sent from the judge's computer terminals to the file server over the internet.

Advantageously, the method further comprises the step of providing information on a forecast grade for the candidate a first set of a plurality of pairs of identifiers is formulated before the first round of Swiss tournament. The information may be provided by a teacher or a member of the student's learning establishment. The first set of pairs would otherwise be chosen at random.

The present invention also provides a system for manipulating data in the assessment of examination answers, the system comprising a file server, examination answers in the form of data routed from a multiplicity of computer terminals, each examination answer assigned with an identifier, the file server having an engine running an algorithm, the algorithm sorting the multiplicity of examination answers into pairs of examination answers using the identifiers and routing each pair of examination answers to a defined judge's computer terminal of a multiplicity of judge's computer terminals, the algorithm comprising the steps of receiving data from the judge's computer terminal indicating which of the examination answers of the pair of answer papers wins over the other of the pair of answer papers, the system using the data in the algorithm, the algorithm comprising a Rasch analysis.

An advantage with using this approach, is that time taken for the processor in the main computer to carry out the computation is at an acceptable level, approximately five minutes on a **??** computer to calculate the first set of pairs. Another advantage is that the number of pairs of papers which are sent out to each assessor's workstation is minimized, thus minimising computer handling in that the number of rounds is minimized and the number of judges or assessors is minimized. Distribution of the answer portfolios will be a minimized, thus saving network traffic and minimizing the number of judgements.

Preferably, the judge's computer terminals have a user interface comprising a visual display unit, wherein the two answers are displayed visually on the visual display unit, viewable sequentially or on the same display at the same time or two different visual display units at the same time. Each answer of the pair of answers may be made available each in its own window which may be sized automatically to fit both windows on one screen, preferably with a “winners” box and a comment box (viewable by the judge only and not other judges of the board of judges.

Preferably, the computer terminals comprise a speaker, wherein said two answers are displayed aurally from the speaker.

Thus there is no need for a list of assessment objectives to mark against; no need for marks; no accuracy problems with the addition of marks to provide an overall total mark; no dependency on a very limited number of Examiners (only one previously, a whole board of Examiners with a system of the present invention); evidence of markers capability; speed of marking.

### BRIEF DESCRIPTION OF THE FIGURES

For a better understanding of the present invention, reference will now be made, by way of example, to the accompanying drawings, in which:

FIG. 1 is a block diagram of a system in accordance with the present invention;

FIG. 2 is a flow diagram showing a first set of steps in a method in accordance with the present invention;

FIG. 3 is a flow diagram of a second set of steps in a method in accordance with the present invention;

FIG. 4 is a flow diagram of a third set of steps in a method in accordance with the present invention;

FIG. 5 is a is a flow diagram of a set of steps in a method for locating misfits in the marking of a portfolio in accordance with the present invention;

FIG. 6 is a is a flow diagram of a set of steps in a method of using an analysis tool for facilitating the assessment of assessors in accordance with the present invention;

FIG. 6A is a screenshot showing a coursework answer on a Judge's terminal;

FIG. 6B is a screenshot shot of the coursework answer shown in FIG. 6, the Judge having clicked on an image of the coursework answer to enlarge the image;

FIG. 7 is a part of a screen shot taken from a Judge's terminal;

FIG. 8 is a part of a screenshot taken from a Judge's terminal, listing judgements to be made;

FIG. 9 is a screenshot from a judge's terminal, listing decided judgements;

FIG. 10 is a screenshot of a window displaying notes fields for a judgement;

FIG. 11 is a screenshot of a window displaying a judgement summary;

FIG. 12 is a screenshot of a window taken from a principal moderator's terminal;

FIG. 12A is a screenshot of a window taken from a principal moderator's terminal;

FIG. 13 is a screenshot of a window taken from a principal moderator's terminal;

FIG. 14 is a screenshot of a window taken from a principal moderator's terminal;

FIG. 15 is a screenshot of a window taken from a principal moderator's terminal;

FIG. 16 is a screenshot of a window taken from a principal moderator's terminal;

FIG. 17 is a screenshot of a window taken from a principal moderator's terminal;

FIG. 18 is a screenshot of a window taken from a principal moderator's terminal;

FIG. 19 is a screenshot of a window taken from a principal moderator's terminal;

FIG. 20 is a screenshot of a window taken from a principal moderator's terminal;

FIG. 21 is a screenshot of a window taken from a principal moderator's terminal;

FIG. 22 is a screenshot of a window taken from a principal moderator's terminal;

FIG. 23 is a screenshot of a window taken from a principal moderator's terminal;

FIG. 24 is a screenshot of a window taken from a principal moderator's terminal;

FIG. 25 is a screenshot of a window taken from a principal moderator's terminal, showing graphs depicting statistical relevance of ranking of the student's answer portfolios;

FIG. 26 is a screenshot of a window taken from a principal moderator's terminal, showing a table ranking student's answers;

FIG. 27 is a screenshot of a window taken from a principal moderator's terminal, showing a graph used in ranking student's answers;

FIG. 28 is a screenshot of a window taken from a principal moderator's terminal, showing a table indicating status of judging;

FIG. 29 is a screenshot of a window taken from a principal moderator's terminal, showing a table indicating status of judging;

FIG. 30 is a screenshot of a window taken from a principal moderator's terminal, showing a table indicating status of the judges; and

FIG. 31 is a flow diagram showing steps in a method for facilitating even distribution of answer portfolios amongst the judges.

### DETAILED DESCRIPTION OF THE PREFERRED EMBODIMENTS

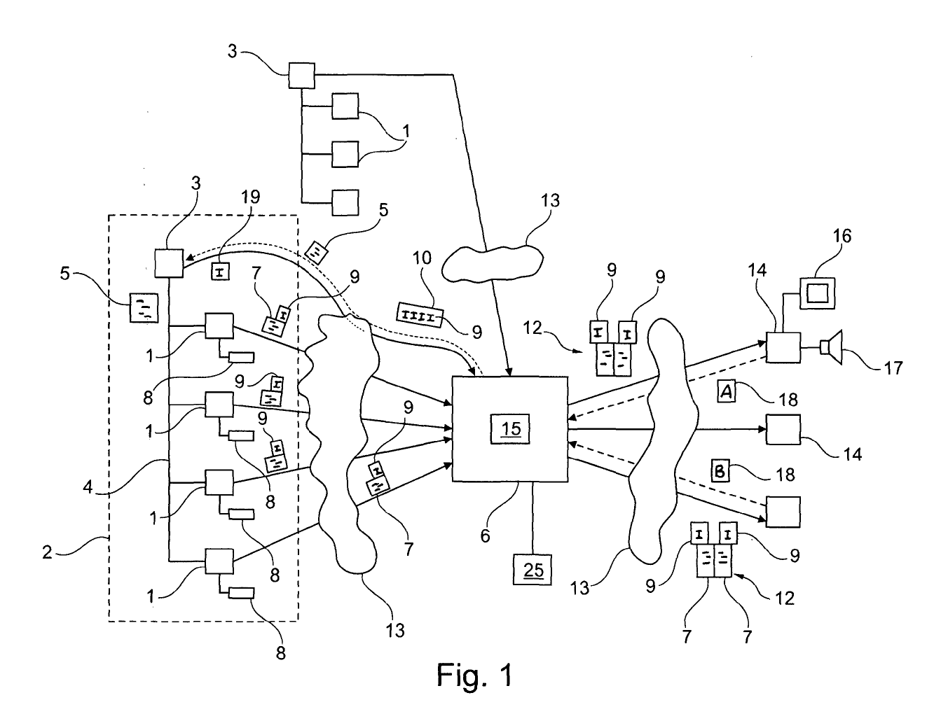

Referring to FIG. 1, there is shown a block diagram of a system in accordance with the present invention. A plurality of students' terminals 1 are located in a classroom 2, one student's terminal for each student. An invigilator's terminal 3 is also preferably located in the classroom 2, although may be distant from the classroom 2.

An invigilator sends a question to the students' terminals 2 from the invigilator's terminal 3 through an intranet 4 to which the students' terminals and invigilator's terminal are connected. The question 5 may be set by an examining body and sent to the invigilator's terminal from an examining body's file server 6. The student answers the question. The student's answer is referred to herein as his portfolio 7. The students submit their portfolios 7 directly to a file server 6 of an examining body. The answer or part of the answer may be prepared on paper and then scanned using a scanner 8 to create an image file in a format such as tiff, Adode® or Flash® and saved on to or via the student's terminal 1. Alternatively, the portfolio 7 could be prepared directly on to the students' terminals 1 using programs such as MAPS™ supplied by the applicant for the present patent application and may be supplemented by the use of application software such as Word®, Excel® and PowerPoint®.

Each portfolio 7 is assigned an identifier 9. A data package 10 containing a plurality of unique identifiers 9 are selected and sent from the examining body's file server 6 to the invigilator's terminal 3. The invigilator forwards a unique identifier 9 to each of the students' terminals for attachment to the student's portfolio 7. Each portfolio 7 submitted from the student's terminal 1 is sent with the unique identifier 9 to the examining board's file server 6 to be assessed. The student submits a portfolio 7 to be assessed from the student's terminal 1. The portfolio 7 may be submitted directly over the internet 13 to the examining body's file server 6 or via the invigilator's terminal 3 to the examining body's file server 6.

The invigilator may also send information pertaining to each student to the examining board's file server 6 in information data packets 11 from the invigilator's terminal. The information about each student may help indicate how able the student is. This information may comprise previous grades, predicted grades and/or an indication of relative ability within the class or group of students. The information data packets 11 are each assigned the respective unique identifier 9 sent for use by the student for sending with the student's portfolio 7.

The file server 6 receives a multiplicity of portfolios 7 with their respective assigned identifier 9 and uses an engine 15 to apply an algorithm to select pairs of answers 12 to be sent to a particular judge's terminal 14 for the judge to make a judgement decision. Each portfolio 7 of the pair of portfolios 12 is sent with their respective unique identifier 9. The answers are displayed on an interface of the judge's terminal 14, such as a visual display unit 16 or a speaker 17. The judge judges which of the answers of the pair of answers 12 is better than the other and sends a judge's data packet 18 back to the file server 6 indicative of which of the answers is the better assessed by judges. The file server uses the judge's data packet 18 in a further algorithm to the select a further pair of answers and to select which judge's terminal the further pair of answers is delivered to.

The engine 15 attempts to create a measure of the quality of the portfolios 7 reviewed. To achieve this each portfolio 7 is assigned a parameter value. This parameter value is a number which represents a measure of probability. The difference between the parameter values of any two portfolios 7 shows the relative probability that, when compared, one portfolio will be determined to be “better” than the other.

At the start of the process the engine 15 knows nothing about the portfolios 7. For this reason a parameter value of all portfolios 7 is initially set to 0 (zero). At the very beginning of the process the only way to generate the portfolio pairs 12 is to choose them at random. Alternatively, additional information about the student's ability is sent in an additional information packet 19 from the teacher's terminal 3. This additional information may include a rating given by the teacher on the ability of the student to answer the question 5, which may be a grading given on a scale of 1 to 5, 1 being very able and 5 being not able. The engine 15 uses this information to create pairs of answers for the first round of judging, by pairing those with the same or similar grading. The additional information may also or alternatively include information on a grade awarded for a previous question answered by the student, the engine 15 using this information to create pairs of answers for the first round of judging, by pairing those with the same or similar grade.

The engine 15 runs a first algorithm to generate portfolio pairs 12 randomly, or by using additional information as set out in the preceding paragraph. The algorithm makes sure that each portfolio 7 is chosen only once. Each portfolio pair 12 is sent to a judge's terminal 14 for a judge to make a judgement decision as to which portfolio 7 of the portfolio pair 12 is the better (“wins”) and which is worse (“loses”) and sends the judge's data packet 18 back to the file server 6 indicative of which of the answers is the better assessed by judge.

At the beginning of the first estimation round the engine 15 creates a first and second dummy portfolio that remain constant throughout all subsequent estimations. Each portfolio 7 is compared to the first dummy portfolio and loses the comparison. This is the “win-all” portfolio. Each portfolio 7 is then compared to the second dummy portfolio and wins the comparison. This the “lose-all” portfolio. The parameter value of the win-all portfolio is fixed at +10. The parameter value of the lose-all portfolio is fixed at −10.

When each portfolio has one decision against it (either “win” or “lose”) the first estimation round begins. At this stage the quality of the information gathered is quite poor. Some of the comparisons will have been very straightforward (if a very good portfolio 7 is compared to a very poor one) and some will less straightforward (if the portfolios 7 are of a similar standard). Because the level of information gathered at this stage is so low, performing a full Rasch analysis is not the most efficient way of proceeding. Instead the pairs engine processes the portfolios using a “Swiss Tournament” system.

The Swiss tournament is commonly used in chess tournaments as an alternative to the more common “knock-out” system. The winner of each pair of answers 12 receives a point. In following rounds the pairs are chosen from groups with the same number of points (or wins). For example, at the start of round three some players will have two points (having won two matches) others will have 1 (won one and lost one) and some will have zero (lost both).

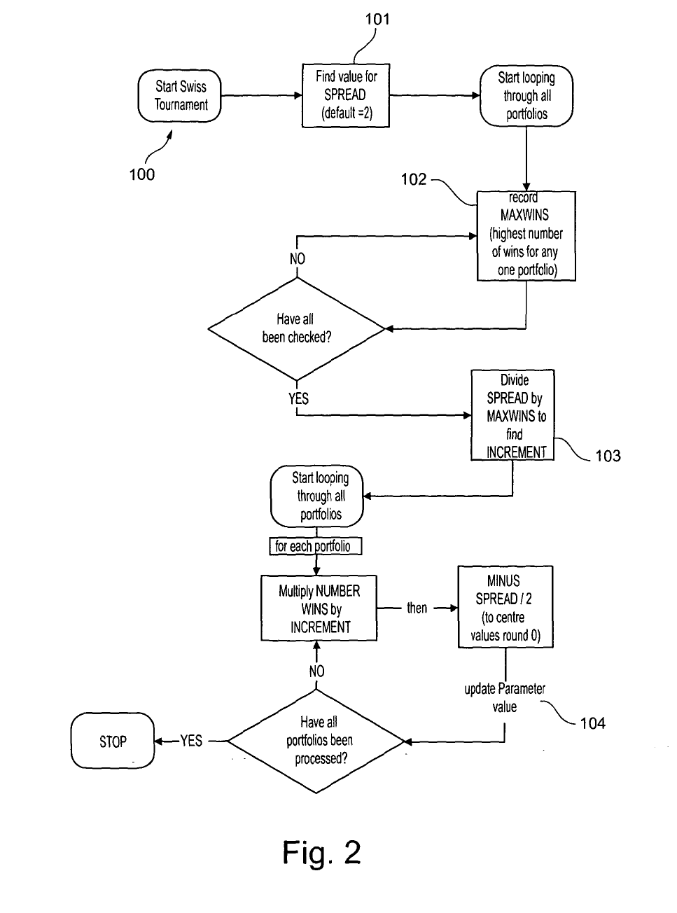

Operation of the Swiss tournament algorithm 100 is set out in FIG. 2, wherein “spread” value 101 is a fixed value for the range of the parameter values (defaults to 2) and “maxwins” 102 is the largest number of wins recorded by a portfolio 7 of the multiplicity of portfolios.

The parameter value for a portfolio “i” with a certain number of “wins” is given by:

$${V}_{i} = ( {wins}_{i} \times ( \frac{spread}{maxwins} ) ) - ( \frac{spread}{2} )$$

The spread 101 is divided by the largest number of wins 102 recorded for the portfolios 7 to find an “increment” 103 for the “maxwins” portfolio. The “increment” 103 is multiplied by the number of wins for each portfolio 7 and half of the spread value 101 is subtracted therefrom to obtain the parameter value 104 for each portfolio 7. By adopting this method in the early stages within the engine 15, portfolios 7, each identified by identifier 9, are compared to other portfolios 7 with roughly the same level of quality. The advantage of this approach is that it attempts to maximise the amount of information available in each comparison. The parameter value 104 for each portfolio 7 is updated each time the portfolio 7 has gone through another round of judging. The parameter value 7 is compared against other portfolios which have been through the same or similar number of rounds to decide on the next pair of portfolios 12, those having the same or similar parameter values 104.

At this stage the algorithm run on in the engine 15 is choosing portfolios 7 that have recorded the same number of wins. The system is also keeping track of which judge has seen which portfolio 7 and is trying to balance out the number of times a single piece of work is reviewed by the same judge. Each judge is assigned a unique judge's terminal 14.

In standard usage, the Swiss tournament approach is used for the first six estimation rounds (although this can be adjusted by the system administrator). At the end of six estimation rounds the portfolios have separated out into seven groups: no wins; one win; two wins; three wins; four wins; five wins; six wins).

The main rationale for using Swiss tournament at the beginning of the process is that it is computationally much lighter and quickly “primes” the system to a point where it has progressed quite far from its initial random state.

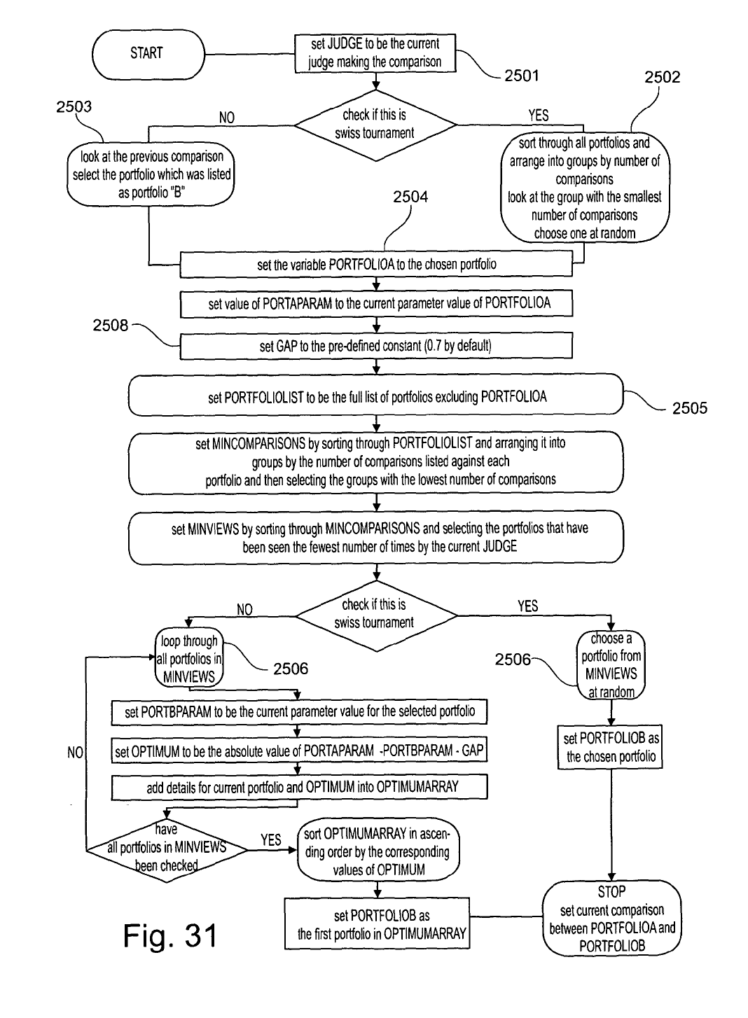

The engine 15 generates further portfolio pairs 12 throughout the Swiss tournament rounds in the same way. Where possible the engine 15 chooses two portfolios 7 that have reached the same score. It attempts to ensure that all judgements are spread across all portfolios 7 evenly, that is that all portfolios 7 have roughly the same number of judgements made against them and it also checks to see how often any single judge has viewed any particular portfolio 7 in an effort to make sure the judges see as much of the multiplicity of portfolios as possible. A flow diagram setting out steps to facilitate an even use of judges is set out in FIG. 31.

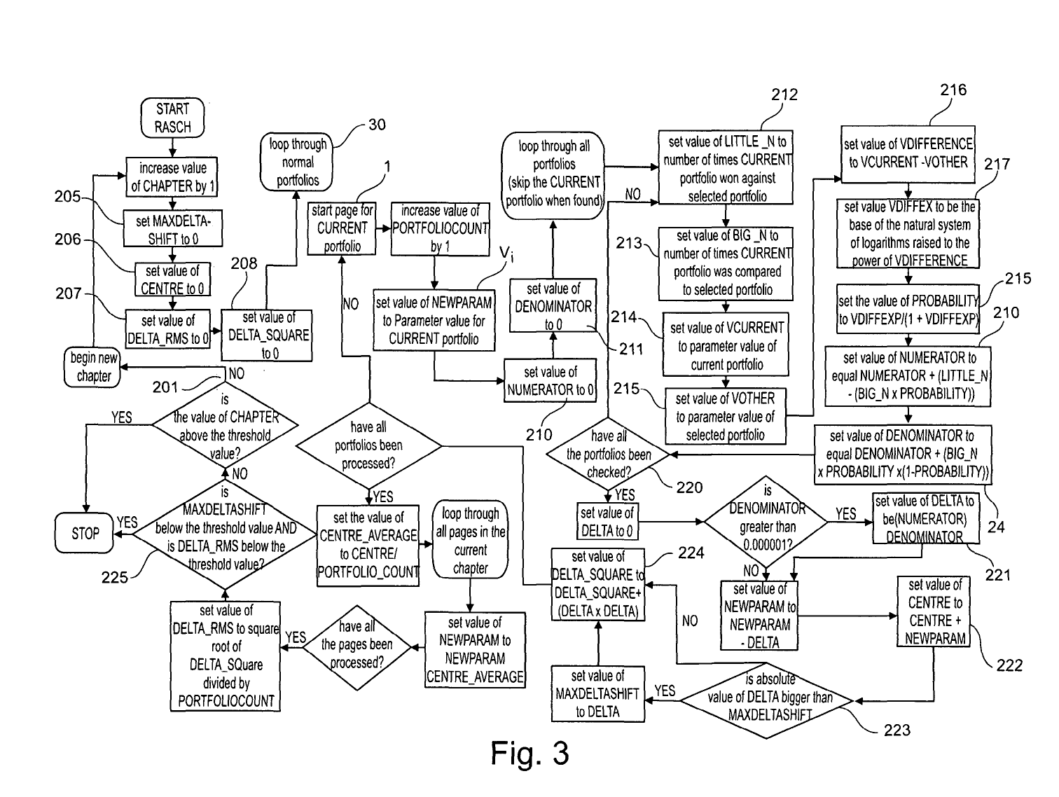

At this point all the portfolios 7 have been involved in seven comparisons. The generated data indicates a rough final order of the portfolios 7. Before the next round, the engine 15 applies a Rasch analysis algorithm as shown in FIG. 3, to the data at the end of the last Swiss tournament.

Each portfolio 7 is subjected to the Rasch analysis algorithm, which comprises the steps of checking the portfolio 7 against all the other portfolios 7 in the system. It looks at how many times they were compared and how many times the current portfolio won and lost. This data is then used to calculate the “ideal” parameter value 202 for this portfolio 7. A separate calculation is then made involving the number of wins and the current parameter Vᵢ value for each portfolio 7. The difference between these two values is noted and a third calculation is made to generate an adjustment figure Δᵢ for the current portfolio 7.

The algorithm continues until it has built a page for every single portfolio 7. At this point it's reached the end of chapter one 201.

As will be appreciated from the below description with reference to FIG. 3, at the end of each chapter the engine 15 goes through and applies an adjustment figure Δ to the parameter value for each portfolio 7. As it does this is makes a note of the square of each of these adjustment figures. When it's applied all the adjustments it calculates the average of the squares of the adjustment figures and then works out the square root of this average (or mean), the Root Mean Square. There is a threshold limit for the root mean square of the adjustment figures. If the root mean square falls below a certain threshold then the estimation process stops—further analysis will make statistically insignificant changes to the system. This is the first condition that stops the estimation. Alternatively, if the algorithm manages to reach the end of chapter 20 it stops. This is the second condition that stops the estimation. If, after 20 iterations, the estimation has not completed, further estimations are unlikely to make any significant progress towards stability.

The engine 15 now goes back through the pages of this chapter and applies an adjustment figure to the parameter value for each portfolio. Now, armed with the updated parameter value 204 for each portfolio, it starts the whole process again with chapter two.

The Rasch algorithm calculates a MAXDELTASHIFT value 205, a CENTRE value 206, a DELTA_RMS value 207 and a DELTA_SQUARE value 208, which are all set to zero before the Rasch algorithm is applied to each portfolio 7 in the chapter 201.

The parameter value Vᵢ is initially set at the parameter value of a first portfolio (i) from the previous round, which is initially the parameter value after the Swiss tournament rounds. Numerator value 210 and denominator value 211 are initially set at zero. The number of wins for the portfolio (i) is entered as LITTLE_N 212. The number of rounds for the portfolio 7 is entered as BIG_N 213. The parameter value Vᵢ of the first portfolio is entered under VCURRENT 214 and the parameter value Vⱼ of a second portfolio 7 is entered under VOTHER 215. VCURRENT is subtracted from VOTHER to obtain VDIFFERENCE 216. VDIFFEXP 217 is set to the base of the natural system of logarithms raised to the power of VDIFFERENCE. VDIFFEXP is divided by one plus VDIFFEXP to obtain PROBABILITY 218, which is the probability of portfolio (i) winning or losing against (j). This routine is expressed by the equation:

$$prob ( i , j ) = \frac{exp ( {v}_{i} - {v}_{j} )}{1 + exp ( {v}_{i} - {v}_{j} )}$$

The engine 15 calculates a NUMERATOR value 210 and a DENOMINATOR value 211 for each portfolio (i). The NUMERATOR is set at the sum of the previous NUMERATOR and the number of wins for the portfolio (i) (LITTLE_N 212) minus the value given by the number of rounds for the portfolio (i) (BIG_N 213) multiplied by the probability of the (i) winning or losing against (j).

This can be expressed by the equation set out below, where “wins” is the number of times this portfolio won when compared to the other portfolio and “comp” is the number of times this portfolio was compared to the other portfolio.

$${num}_{i} = {\sum }_{j , j \neq i} {wins}_{ij} - ( {comp}_{ij} \times prob ( i , j ) )$$

The DENOMINATOR is set at the sum of the previous DENOMINATOR and the value given by the number of rounds for the portfolio (i) (BIG_N 213) multiplied by the probability of the (i) winning or losing against (j) multiplied by a value given by one minus the probability.

$${denom}_{i} = {\sum }_{j , j \neq i} {comp}_{ij} \times prob ( i , j ) \times ( 1 - prob ( i , j ) )$$

The probability for each portfolio is calculated, as shown in the FIG. 3 using a loop 220 through the following process until a stop condition is met. (loop 1) Start the first chapter.

When the above figures have been calculated the adjustment figure Δᵢ is calculated as shown in the flow diagram of FIG. 3 in box 221 by the negative of the NUMERATOR divided by the DENOMINATOR.

$${Δ}_{i} = \frac{- ( {num}_{i} )}{{denom}_{i}}$$

The current parameter value is adjusted by the calculated Δᵢ.

Vᵢ=vᵢ−Δᵢ

For the full set of portfolios (N) the average of the new parameter values is calculated as:

$$\overline{V} = \frac{{\sum }_{n = 1}^{N} {V}_{n}}{N}$$

Each new parameter value is then updated to centre them around 0, as shown in box 222.

V_{centre}=Vᵢ− V̅

The value of MAX_delta is updated to be a record of the maximum absolute value of Δ, as shown in box 223.

A Root Mean Square (RMS) of the Δ values is calculated, as shown in box 224 and given by the equation:

$${Δ}_{rms} = \sqrt{\frac{{\sum }_{n = 1}^{N} {( {Δ}_{n} )}^{2}}{N}}$$

The estimation process continues in this way, building up pages and adding chapters until one of two conditions is met. This is carried out by performing the above calculation on each portfolio 7 in a loop and then checks to see if the MAX_delta and the Root Mean Square of the delta Δ values, as shown in box 225 both fall below the threshold values then the figures are stable and the estimation process stops.

The threshold for MAX_delta is preferably 0.01 and the threshold for root mean square of the delta is preferably 0.001.

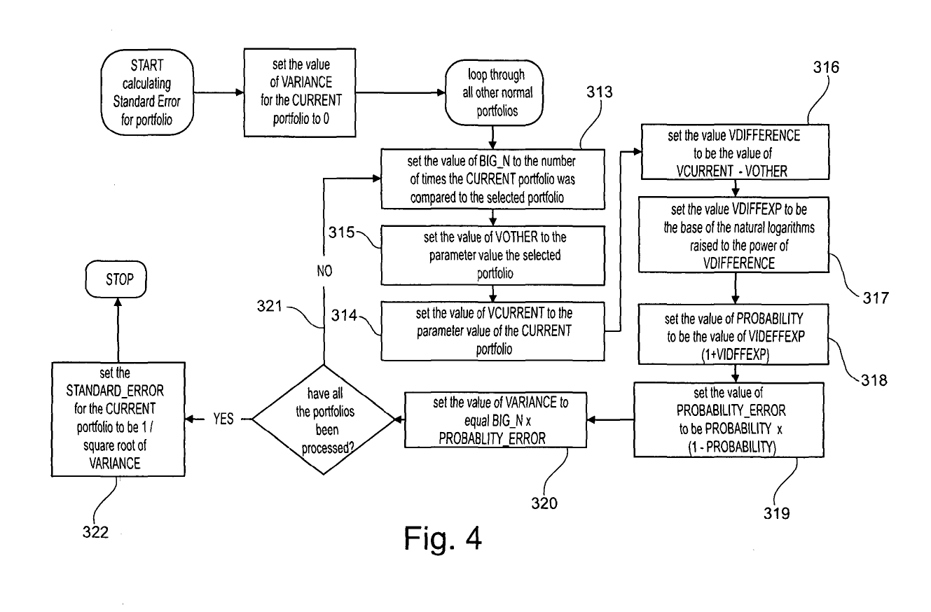

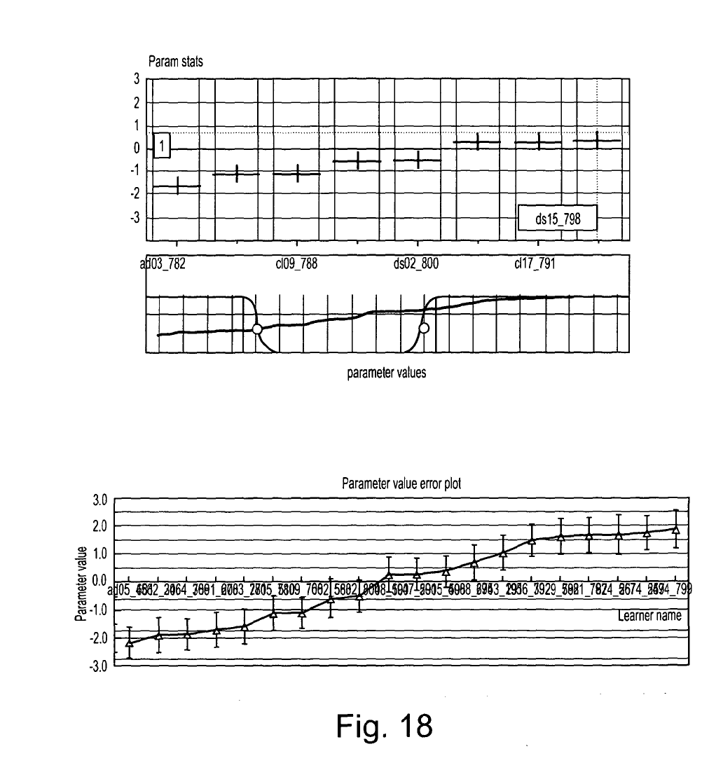

When the full estimation process completes, the final parameter value adjustments are made and the system generates the graphical data that is presented to the system administrators, as shown in FIG. 18. Referring to FIG. 4, there is shown a flow diagram showing a routine for calculating standard error for the multiplicity of portfolios, using data from each of the portfolios 7. At the start of the routine, VARIANCE is set to 0, then a loop for all the porfolios 7 is carried out using The number of rounds for the current portfolio 7 is entered as BIG_N 313. The parameter value Vᵢ of the current portfolio is entered under VCURRENT 314 and the parameter value Vⱼ of a second portfolio 7 is entered under VOTHER 315. VCURRENT is subtracted from VOTHER to obtain VDIFFERENCE 316. VDIFFEXP 317 is set to the base of the natural system of logarithms raised to the power of VDIFFERENCE. VDIFFEXP is divided by one plus VDIFFEXP to obtain PROBABILITY 318, which is the probability of portfolio (i) winning or losing against (j). A PROBABILITY_ERROR 319 is set at PROBABILITY multiplied by the sum of one minus the PROBABILITY. VARIANCE 320 is calculated as the number of rounds for the current portfolio 7 (BIG_N 213) multiplied by the PROBABILITY_ERROR. When all portfolios 7 have been processed in the loop 321, STANDARD ERROR 322 is calculated as the inverse of the square root of the VARIANCE. The above routine can be expressed in the form of the below equation to calculate standard error for the graphical display:

$${se}_{i} = \frac{1}{\sqrt{{\sum }_{j , j \neq i} ( prob ( i , j ) \times ( 1 - prob ( i , j ) ) )}}$$

If the number of “chapters” reaches the threshold value (twenty by default) then the figures are considered to be inherently unstable and the estimation process stops.

With the Rasch analysis completes, each portfolio has now been assigned a final parameter value V. These values range from a maximum of 10 to minimum of −10. A high parameter value indicates a high quality of work and a high probability that this portfolio will “win” when compared to another portfolio. A low parameter value indicates a low quality of work and a low probability that this portfolio will “win” a comparison. Portfolios with a parameter value of 0 (zero) should have a roughly even chance of winning or losing a comparison.

Having used the Rasch analysis model for the first time at the end of the 7th estimation round, the algorithm for choosing the pairs also changes. Now, instead of grouping portfolios by the number of wins, the engine 15 compares the parameter values of each portfolio 7 and tries to find portfolios who's parameter value V is roughly 0.7 above or below the current portfolio's parameter value Vᵢ. The reasons for the apparently arbitrary figure is that it forces the system to try to choose the most efficient pairings. From a theoretical perspective, the greatest amount of information is added to the system when comparing portfolios with nearly equal parameter values. This is good in theory but becomes difficult in practice as these are likely to be hardest judgements to make. So, by looking for portfolios where the difference in the parameter values is roughly 0.7, this maximises the quality of the information gathered from each comparison whilst hopefully preventing these comparisons from becoming unnecessarily hard.

Some of the same rules apply to this updated algorithm—balance the overall number of judgements, balance the number of times a portfolio has been seen by the same judge, try to prevent the same pair being shown to the same judge. A new feature of this updated algorithm is the concept of chaining. Chaining is another method to help make the process easier for the judges. Chaining simply means that having completed a comparison between two portfolios, that the next comparison should contain one of the portfolios 7 from the previous pair. This means that the judge is only having to review one portfolio 7 in detail each time and can more quickly review the details of the other portfolio that they have already processed.

The judging continues in this way with each new estimation round being triggered as before, when all the portfolios have been involved in one more comparison. As each estimation round is completed the parameter values for each portfolio 7 can be reviewed as well as the summary data for the whole estimation process. Each round builds on the results of the previous round until a state of stability is reached. As with the detailed estimation process, more data will always generate a more accurate result but in practice the results do reach a point of stability after which further judgements will make very little difference to the final figures.

One key feature of the engine 15 and the Rasch algorithm, is the level of quality control it offers through the generation of mis-fit statistics. As the system builds up more and more information about the portfolios and their related parameter values, it becomes better able to make more accurate predictions about which portfolio 7 will win from a given pair of portfolios 12. It is possible, even quite likely, that some portfolios 7 will be harder to judge than others, not necessarily because the quality of the work is particularly good or particularly bad but because aspects of the portfolio 7 make it appear more likely to win when compared to some portfolios 7 and more likely to lose when compared to others. This may well go against the predicted result provided by the parameter values V. It's also likely that the predictability of the judgements made by the judges will vary. The engine 15 is based on the idea of holistic judgement. There are, quite deliberately, no set criteria for how the judgements should be make, but the judges have been chosen because of their anticipated ability to provide a sound professional opinion and the likelihood that, on balance, that opinion will be shared by their colleagues. A set of learning objectives may be useful in the judging, but a full marking schedule is not required.

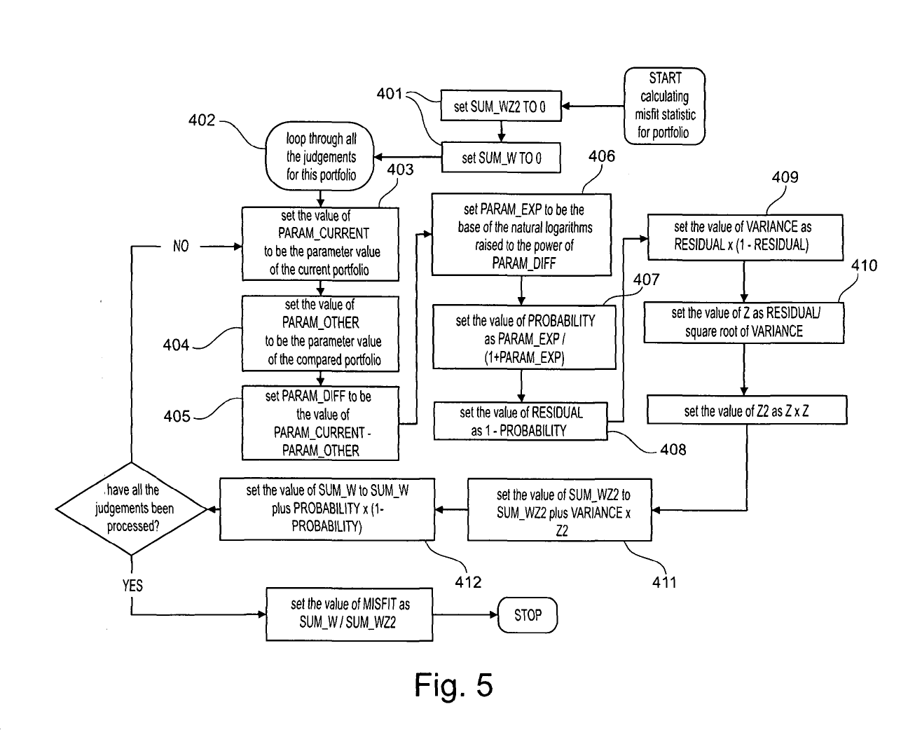

For each portfolio 7, the routine set out in FIG. 5 is followed to calculate and display graphically a representation from which is easily discernable if there are any portfolios which have lost against portfolios when they were predicted to have won, i.e. if there is a mis-fit statistic for a portfolio.

The first step in the routine shown in the flow diagram in FIG. 5 is to set SUM_WZ2 and SUM_W 401 to zero, then all of the judgements 402 for this portfolio is looped through the routine, setting PARAM_CURRENT 403 to the current parameter value of the current portfolio Vᵢ and set PARAM_OTHER 404 to the parameter of the compared portfolio Vⱼ. Subtracting PARAM_CURRENT from PARAM_OTHER to obtain PARAMA_DIFF 405. PARAM_EXP is set to the base of natural logarithm raised to the power of PARAM_DIFF. PROBABILITY 407 is calculated by dividing PARAM_EXP by the sum of one plus PARAM_EXP. A RESIDUAL 408 is calculated as one minus the PROBABILITY. VARIANCE 409 is calculated as RESIDUAL multiplied by the sum of one minus RESIDUAL. Z is calculated as RESIDUAL divided by the square root of the VARIANCE and Z is multiplied by itself and set as Z2 and then the SUM_WZ2 411 value is set to SUM_WZ2 plus VARIANCE multiplied by Z2. SUM_W 412 is set as SUM_W plus PROBABILITY multiplied by the sum of one minus probability. Misfit is calculated as SUM_W divided by SUM_WZ2.

For each portfolio there is a set of N judgements made on the current portfolio as “i” and the portfolio being compared against as “j”, the above routine is expressed by the equation:

$${W}_{i} = {\sum }_{j , j \neq i} prob ( i , j ) \times ( 1 - prob ( i , j ) )$$

$$\text{?} = {\sum }_{j , j \neq i} ( 1 - prob ( i , j ) ) \times prob ( i , j ) \times {( \frac{1 - prob ( i , j )}{\sqrt{( 1 - prob ( i , j ) ) \times prob ( i , j )}} )}^{2}$$

$$\text{?} \text{indicates text missing or illegible when filed}$$

With the above figures calculated the final misfit figure can be determined using the following.

$${misfit}_{i} = \frac{{W}_{i}}{{W}_{z {2}_{i}}}$$

For each judge, judgement 18 and portfolio 7 there is a level of expected “fit”, a predictable result that confirms the placement of that portfolio 7 in the overall order. There may be some disagreements between judges these unexpected results are expressed through the level of a “mis-fit” statistic. The mis-fit statistic for a portfolio 7 shows the extent to which it has been unexpectedly judged a winner or a loser. The mis-fit statistic for a judge shows the extent to which they have made judgements that contradicted the expected result from the parameter values.

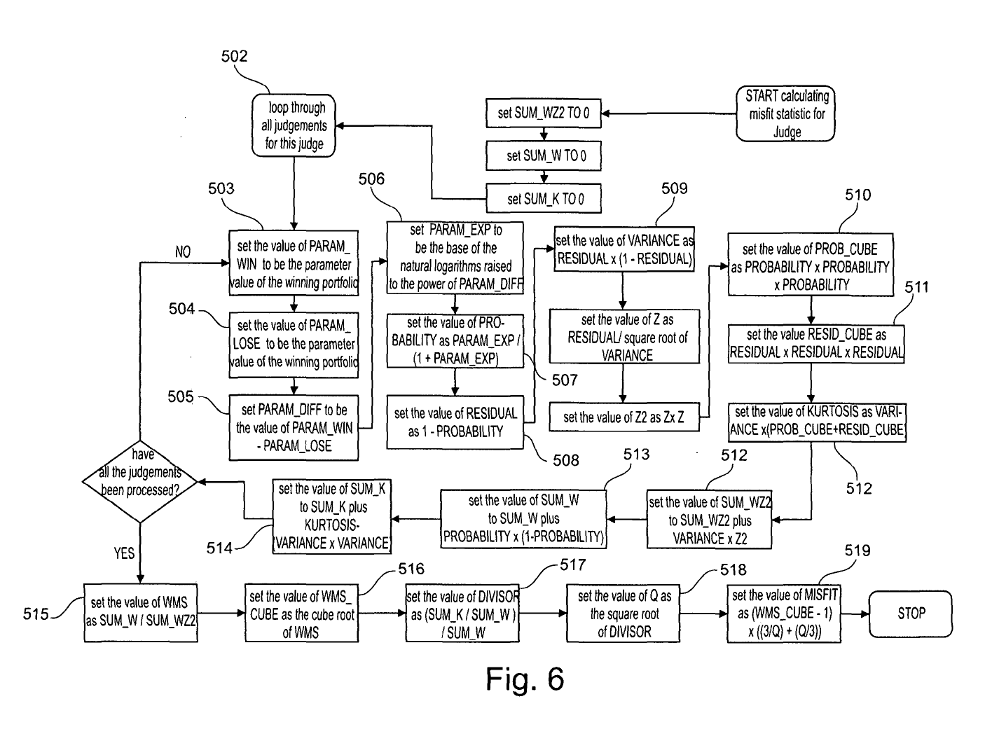

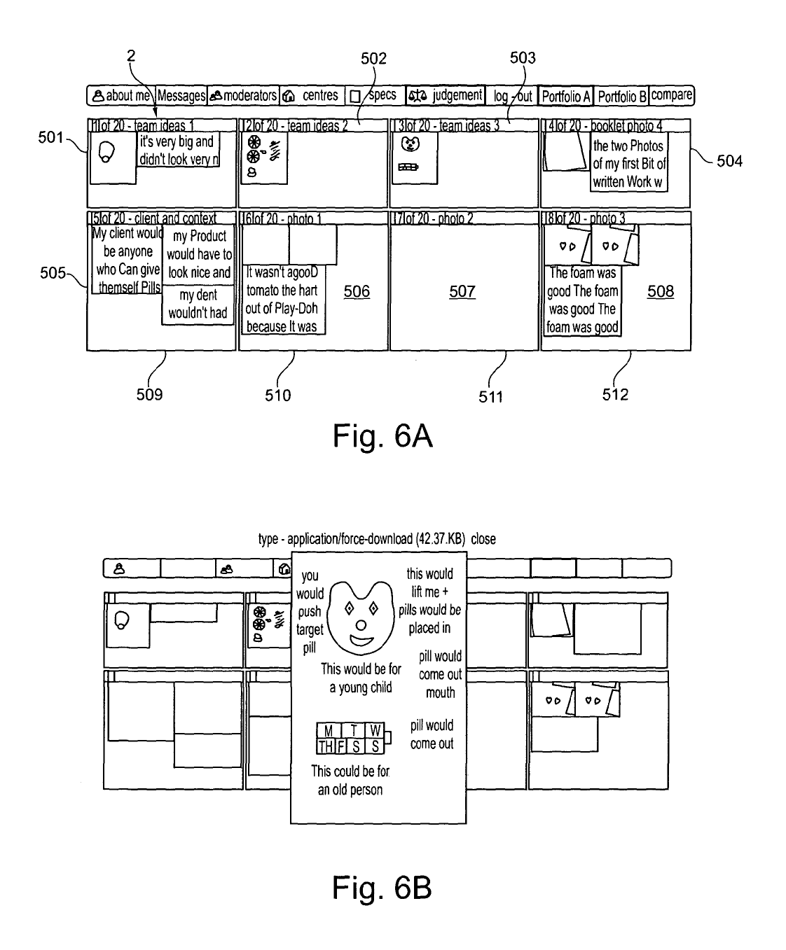

The routine set out in FIG. 6 is followed to calculate and display graphically a representation from which is easily discernable if there are any judges which are not judging in consistently the same manner as the other judges i.e. if there is a mis-fit statistic for a judge.

The first step in the routine shown in the flow diagram in FIG. 6 is to set SUM_WZ2, SUM_W and SUM_K to zero. All of the judgements 502 made for by this judge are looped through the routine, setting PARAM_WIN 503 to be the parameter value Vᵢ of the winning portfolio and setting PARAM_LOSE 504 to be the parameter value Vⱼ of the losing portfolio. Subtracting PARAM_WIN from PARAM_LOSE to obtain PARAMA_DIFF 505. PARAM_EXP 506 is set to the base of natural logarithm raised to the power of PARAM_DIFF. PROBABILITY 507 is calculated by dividing PARAM_EXP by the sum of one plus PARAM_EXP. A RESIDUAL 508 is calculated as one minus the PROBABILITY. VARIANCE 509 is calculated as RESIDUAL multiplied by the sum of one minus RESIDUAL. Z is calculated as RESIDUAL divided by the square root of the VARIANCE and Z is multiplied by itself and set as Z2 and setting a value for PROB_CUBE 510 as PROBABILITY multiplied by PROBABILITY multiplied by PROBABILITY. Then setting a value for RESID_CUBE 511 as RESIDUAL multiplied by RESIDUAL multiplied by RESIDUAL. Setting a value for KURTOSIS as VARIANCE 509 multiplied by the sum of PROB_CUBE 510 and RESID_CUBE 511. Then the SUM_WZ2 512 value is set to SUM_WZ2 plus VARIANCE multiplied by Z2. SUM_W 513 is set as SUM_W plus PROBABILITY multiplied by the sum of one minus probability. Misfit is calculated as SUM_W divided by SUM_WZ2. SUM_K 514 is set as Sum_K plus KURTOSIS minus the VARIANCE squared.

WMS 515 is set as SUM_W divided by SUM_WZ2.

WMS_CUBE 516 is set as the cube root of WMS.

DIVISOR 517 is set as SUMK divided by SUM_W then divided by SUM_W.

Q 518 is set as the square root of the DIVISOR.

For each judge there is a set of N judgements with a

$${W}_{judge} = {\sum }_{n = 1}^{N} prob ( i , j ) \times ( 1 - prob ( i , j ) )$$

winning portfolio “i” and a losing portfolio “j”

$${W}_{z {2}_{judge}} = {\sum }_{n = 1}^{N} ( 1 - prob ( i , j ) ) \times prob ( i , j ) \times {( \frac{1 - prob ( i , j )}{\sqrt{( 1 - prob ( i , j ) ) \times prob ( \text{?} )}} )}^{2}$$

$${κ}_{judge} \text{?} {\sum }_{n = 1}^{N} ( prob ( i , j ) \times ( 1 - prob ( i , j ) ) \times ( ( prob ( i , j ) ) \text{?} + ( 1 - prob ( i , j ) ) \text{?} ) ) - ( prob ( i , j ) \times ( \text{?} \\ \text{?} \text{indicates text missing or illegible when filed}$$

With the above figures calculated the final misfit figure can be determined using the following equation:

$${WMS ( cube )}_{judge} = \sqrt[\text{?}]{\frac{{W}_{judge}}{{W}_{z {2}_{judge}}}}$$

$${Q}_{judge} = \sqrt{\frac{( \frac{{κ}_{judge}}{{W}_{judge}} )}{{W}_{judge}}}$$

$$\text{?} \text{indicates text missing or illegible when filed}$$

MISFIT 519 is calculated using he below equation:

$${misfit}_{judge} = ( {WMS ( cube )}_{judge} - 1 ) \times ( ( \frac{3}{{Q}_{judge}} ) + ( \frac{{Q}_{judge}}{3} ) )$$

It's important to stress here that there are no specifically right or wrong answers and the mis-fit statistic should be read as being indicative of a general trend rather than any inherent inaccuracies. What it does allow though is for the system administrator to review the health of the judging process and more easily pinpoint either those judges that may need some extra guidance or those more unusual or quirky portfolios that need to be discussed in more detail.

The current engine 15 defaults to a maximum of twenty rounds. This, along with many other variables, can be adjusted by the system administrator/principal moderator when the judging process is being set up. The system administrator does have the ability to prolong the judging process if they deem it necessary. They can also move allocated judgements from one judge to another (for example if one judge becomes ill or unable to work, their judgments can be distributed amongst the remaining team).

The final parameter value V for each portfolio 7 may simply stay be displayed to the student as a position out of the number of portfolios assessed. Alternatively, each portfolio 7 is assigned a grade derived from the final parameter value V, for example the parameter value, ranging from 10 to −10, may be converted into a more traditional scores or pass marks, such as 50% for a C, 70% for an A. There are computational tools that can help with the analysis required to undertake this process, but there is no way to computationally complete the process. This will always require professional review and discussion in order to agree where the boundaries should lie. One feature of the pairs engine that is available to help is the ability to enter a grade boundary phase. This is where a sub-set of portfolios and judges is chosen from the full set and further judgements are then made with those portfolios. The grade boundary analysis uses the exact same algorithms for choosing the portfolios and for processing the estimation round as are used in the main system. This provides the awarding body with the ability to create finer levels of distinction between the portfolios that lie on or near the points where the grade boundaries have been determined to lie. If seed portfolios have been included (work of a known quality from previous years) their location in the order can also be reviewed to give the awarding body a better sense of where the grade boundaries should sit. Again, the analysis and significance of the final location of seed portfolios in the rank order will rely on professional interpretation rather than any automated process.

As previously stated, the engine 15 is part of the general awarding body computer system. The judges log in to their accounts and stepping through the comparative process. As such their usage of the system is relatively straightforward. They have some limited functions to manage their account information but fundamentally they just check through the list of paired comparisons the system generates for them.

The second group of users are the administrators, also known as principal moderators or examination officers. These users have a more in-depth role and utilise many more features of the system. They are the users that set up, monitor and then analyse the information generated by the system.

A student preferably prepares his portfolio on a student's terminal 1 using a visual interface shown in FIG. 6A. The question 5 is answered in the form of diary entries in cells 501 to 512. Each cell 501 to 512 is zoomable, as shown in FIG. 6B. Text, audio files, video files and picture files may be placed and viewed and/or run in each cell. The answer in each cell 501 to 512 makes up a portfolio 7 which is submitted when the answer is complete. The student may prepare his answer using an interface produced by the applicants for the present case and marketed under the trade mark MAPS.

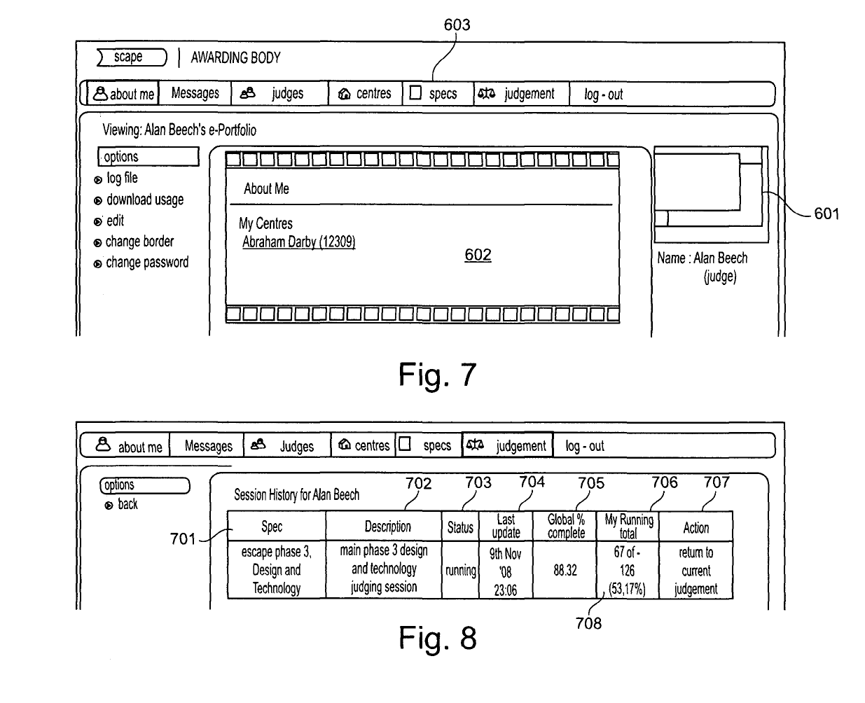

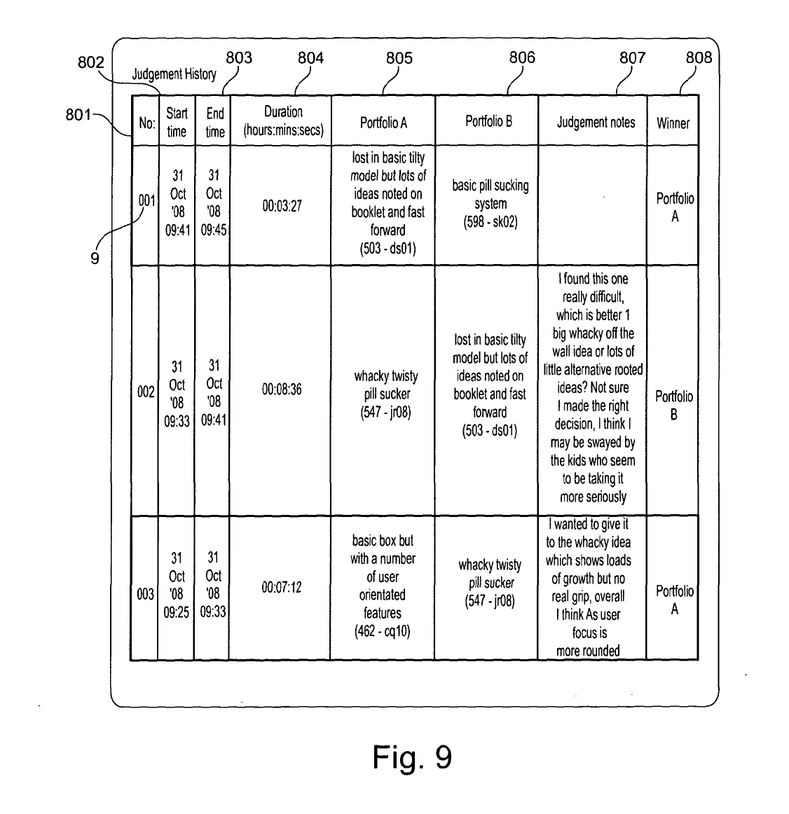

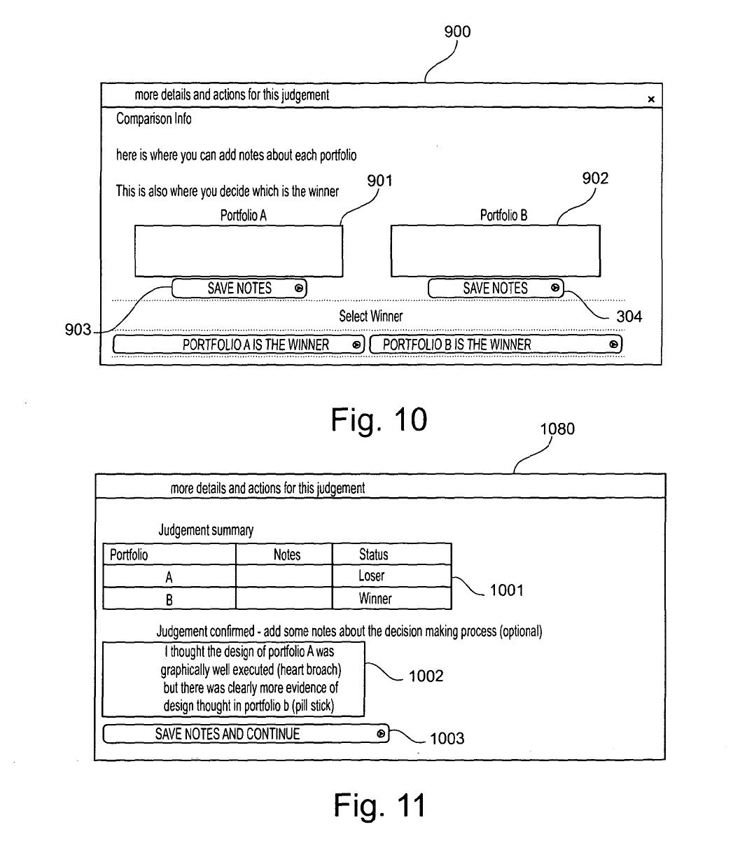

FIG. 7 shows a screenshot of a Judge's terminal 14. The screenshot shows a window 601 on the right hand side of the screen identifying the judge, to ensure the judge is correctly logged in. A main window 602 displays an About Me page and incorporates a list of centres for which he is a judge. Clicking on the “judgement” tab 603 navigates the judge to a Session History page 6 shown in FIG. 8, thus accessing the engine 15. A summary of all their current judgements is shown. A “Spec” column 701 displays details an exam specification for the listed session (in general terms the subject it's related to, Maths, English, Geography etc.). A “Description” column 702 displays more specific detail given to this session by a principal moderator. A “Status” column 703 is the current state of the session: running; paused; or stopped. A “Last update” column 704 displays a time-stamp which details the last time any aspect of the session was changed. A “Global % complete” column 705 displays a number which represents what percentage of the overall judgements from all the judges in the session have been completed. A “My Running total” column 706 gives a more specific listing of how much work this judge has done in this session (expressed as a percentage in parenthesis). An “Action” column displays a link which will either be “not available” if the session has been stopped or paused, “go to first judgement” if no comparisons have yet been made by this judge in this session, “return to current judgement” if the current comparison is pending or “start next judgement” if the previous comparison has been completed. The numbers 708 listed in “My Running total” are also a link to a judgement history page, shown in FIG. 9 for this judge for this session. If no judgements have been made yet, no link option will be available. As displayed in FIG. 9, the Judgement History is listed in reverse chronological order, the most recent judgement is shown at the top. The Judgement History page shows entries in a table with column headers: “No.” column 801 displaying an identifier 9; a “start time” column 802 displaying the start time indicating when the time the pair was generated and first viewed; an “end time” column 803 displaying the end time indicating when the judge ended his judgement; a “duration” column 804 is the difference between these two times; a comment field 805 for Portfolio A; a comment field 806 for Portfolio B; a Judgement Notes field for the judge to view notes about the judgement; and a “Winner” field. If no winner has yet been decided this last column is listed as “-in progress-”.

When clicking in the “Action” link in the session history page the judge is taken to the comparison view for the current judgement. [??]

A “Comparison” window 900 provides comment boxes for Portfolios A and B comments to be left by the judge and the comments to be saved using buttons 903 and 904. buttons 905 and 906 are provided to select a winner: Portfolio A; or Portfolio B. A confirmation window (not shown) is provided to inhibit the judgement from being submitted in error. Portfolio A and/or Porfolio B are viewable on a main window (not shown).

FIG. 11 shows a judgement summary window 1000, which displays a table 1001 displaying the winner and loser and provides a window 1002 for comments on the judgement and button 1003 for saving the comments.

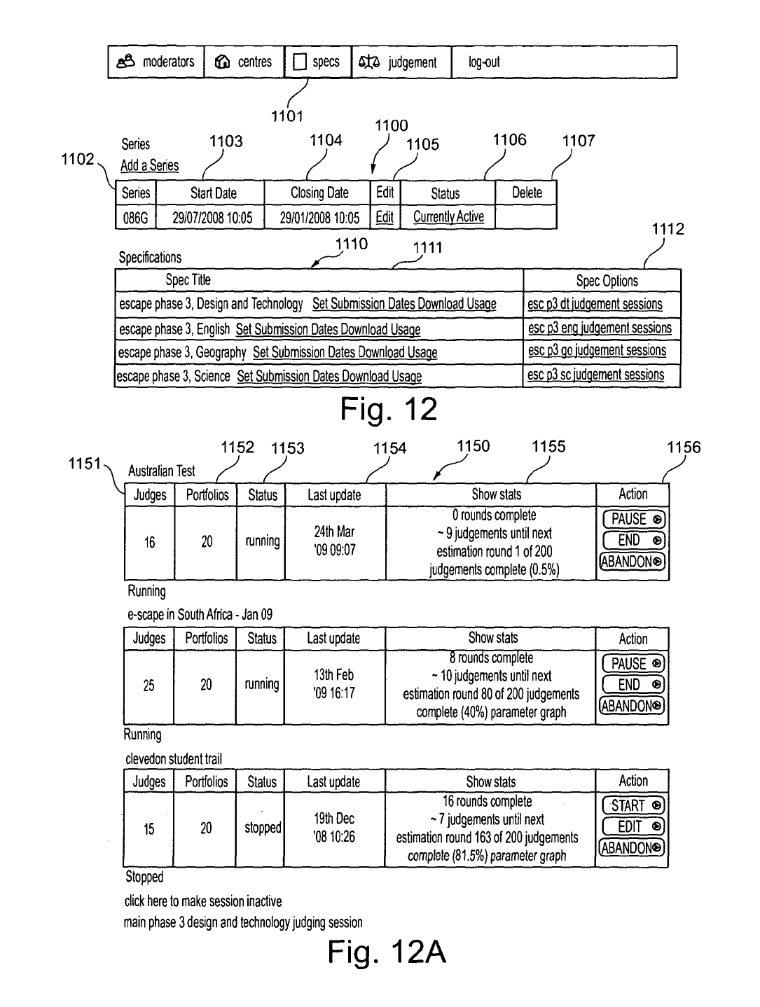

FIG. 12 shows a screenshot from an administrator's terminal 25, which is used by a principal moderator, showing a table 1100 under a “specs” tab 1101. The table displays all of the judgement sessions the principal moderator has control over. A “series” column 1102 displays a list of reference numbers referring to different judgement sessions. A “start date” column 1103 indicating when the assessments began. A “closing date” column indicating when the assessments need to be completed by. An “edit” column 1105 providing a link to another screen. A “status” column 1106 providing a link to a status history screen. A “delete” column 1107 to enable the judgement sessions to be deleted.

A specification table 1110 is provided to list specification title 1111 and options 1112.

FIG. 12A shows a table 1150 comprising details and status of each judgement session, showing: a “judges” column 1151 indicating how many judges are working on the judgement session; “portfolios” column 1152 indicating the number of portfolios being assessed; a “status” column 1153 indicating status, running, completed; “show stats” column 1155 displaying number of rounds completed, number of judgements to be completed before next round and the overall number of judgements that are expected to be made and number completed; and an “action” column showing buttons pause, end and abandon.

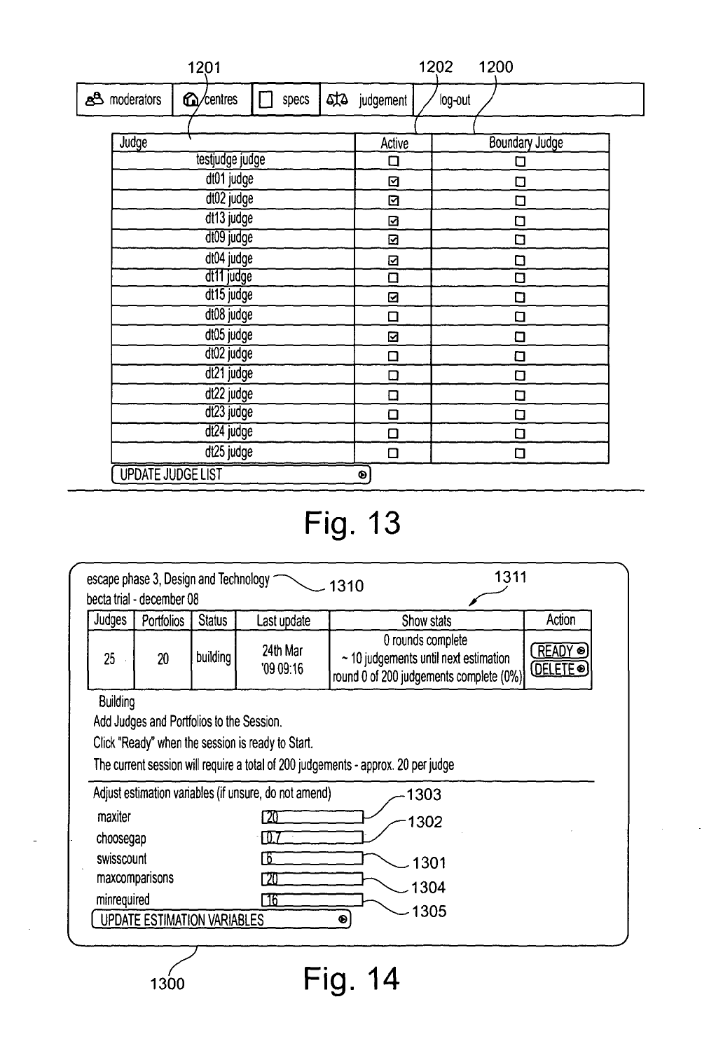

FIG. 13 shows a table 1200 of judges with a “Judge” column 1201 displaying the judges names or other identifier; an “active” control column 1202 allowing the principal administrator to activate or deactivate a judge from the judgement session; and a boundary judge control column 1203. The Principal Moderator refines the overall result by moving into a Grade Boundary mode. The purpose of this is to more accurately determine the parameter values for those portfolios determined to be sitting at or near the boundary between one grade mark and another. Because this sub set of answer portfolios is smaller than the full set it's likely the full complement of judges from the main round will not be required. The Principal Moderator can use the Boundary judge control column 1203 to generate a sub-set of judges to participate in this phase (should it be deemed necessary to run), which comprises at least one further round of pairing and judging, but only on a limited number of answer portfolios at or near a grade boundary.

FIG. 14 shows a control table 1300 from which the principal moderator can vary the number of Swiss tournament rounds in box 1301; the “gap” value 1302 which is the parameter value difference used in the rounds subsequent to the Swiss tournament rounds once the Rasch analysis has been carried out; a “Maxiter” value 1303, which is the maximum number of iterations or chapters used in the Rasch analysis; a “Maxcomparisons” field 1304 which is the maximum number of rounds of pairs of portfolio judgements each portfolio should go through; and “Mincomparisons” field 1305 which is the minimum number of rounds of pairs of portfolio judgements each portfolio should go through. The control table 1300 also displays a title 1310 for the judgement session and a status table 1311.

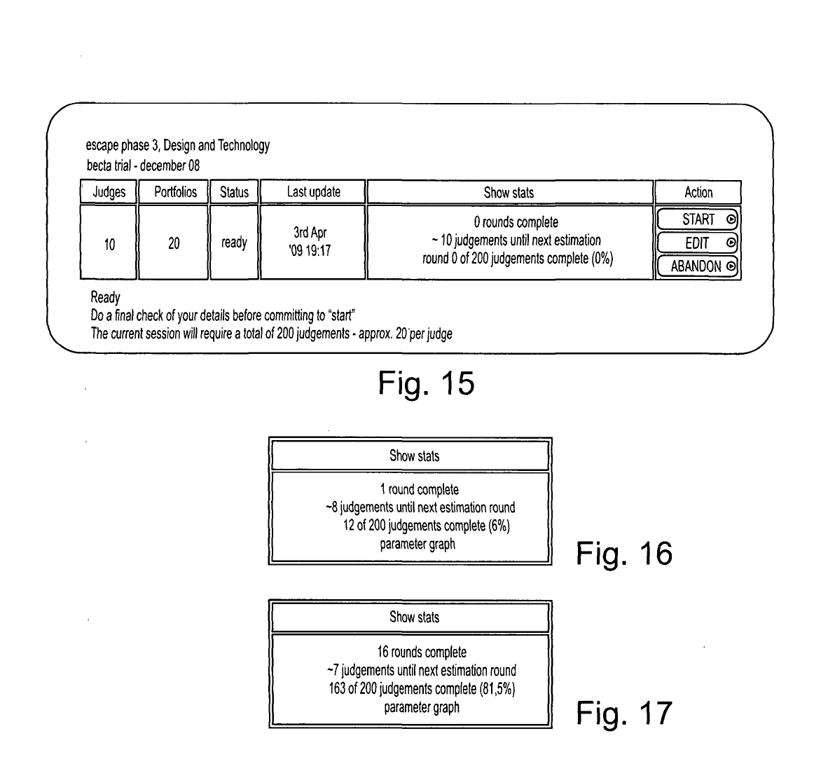

FIGS. 15, 16 and 17 show sets of statistics relating to current judgement sessions.

The principal moderator can create a new judgement session, as well as monitor current judgement sessions.

FIG. 18 shows two graphs, the top one is interactive, the bottom one is a static view of the whole session. The example shown is taken from a session with twenty portfolios, a relatively small number. Normally these graphs to contain data for hundreds of portfolios.

Both graphs list the portfolios in order of their parameter value from smallest to highest. As outlined above the values range from a parameter value of a minimum of −10 to a potential maximum of +10 for each portfolio. The vertical lines in the lower graph show the standard error of the sampling for the parameter value for that portfolio. The same data is displayed in the interactive graph. The top section shows the data, the values display in red when the mouse is moved around the points—clicking on the points take the Principal Moderator to a screen showing the full details of the portfolio. The lower section of, the interactive graph shows the full range of the data set and allows the user to change the width of the area shown in the upper section. The black circles are “handles” that can be dragged left and right to broaden or narrow the focus of the upper section.

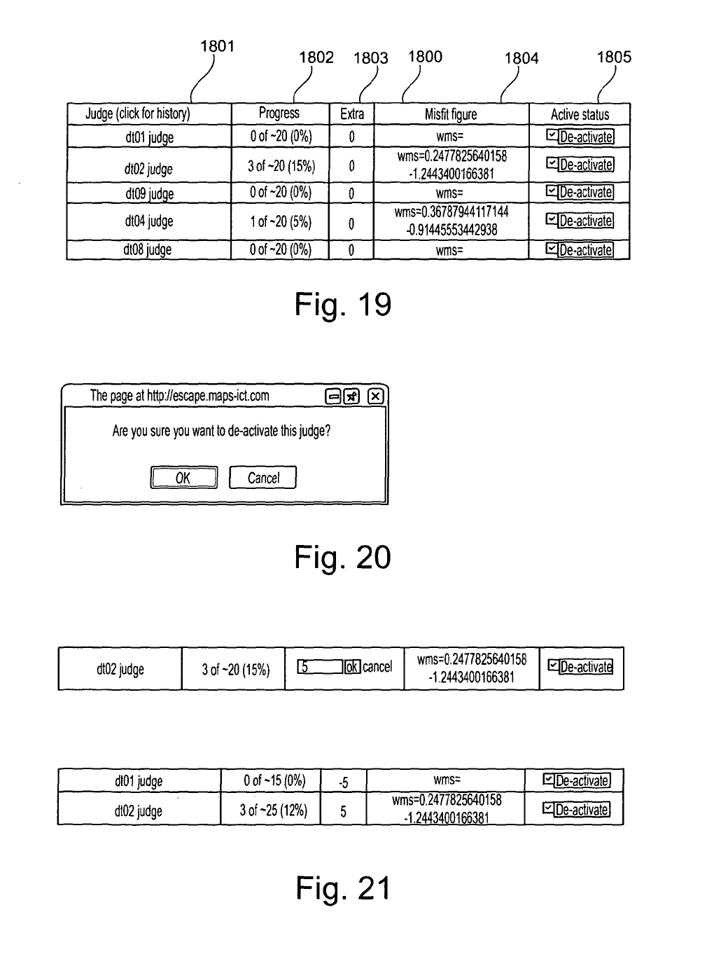

FIG. 19 shows a window of a screen shot from an administrator's terminal showing a judge's assessment table 1800, which has a “Judge” column 1801 identifying the judge and providing a link to a full table of the judge's history; a “progress” column 1802 for displaying the number of completed judgements; an “extra” column 1803 to allow the principal moderator to redistribute the judgements between the judges; a “misfit” column 1804 for displaying a figure giving an indication of how the judge's judgements agree with those of the other judges; and an “active status” control column 1805 to allow the principal moderator to activate or deactivate a judge. FIG. 20 shows a window requesting confirmation of a decision by the Principal Moderator to deactivate a judge.

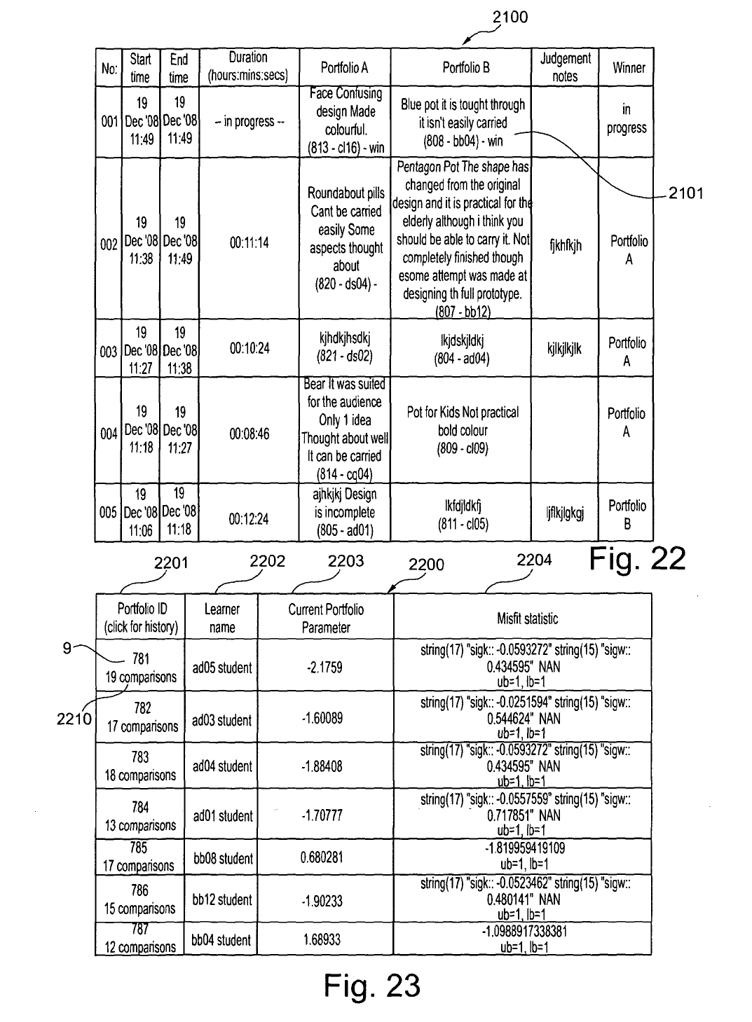

FIG. 22 shows a history page 2100 as viewed from an administrator's terminal 25 setting out details of a particular judge's judgement history in reverse chronological order. The details are the same as those shown in FIG. 9 taken from a judge's terminal. The link in brackets at the end of each portfolio column 2101 shows a full view of that portfolio. The page also details the portfolio notes this judge has made for that portfolio and any judgement notes they left for the particular judgements. If any judgements are still in the progress (as in the example above) the link to the portfolio is followed by a small link with the word “win”. This feature allows the Principal Moderator to manually make the judgement. This has been included to only be used in “emergency” scenarios where the judge is suddenly incapable of accessing the system.

FIG. 23 shows a table 2200 displaying: a “portfolio ID” column 2201 displaying identifier 9 for each portfolio and a number of comparisons the portfolio has had; a “learner name” column 2202 for displaying the student's name; a “current portfolio Parameter” column 2203 for displaying the portfolio's current parameter value; and a “misfit Statistic” column 2204 for displaying data indicative of agreement of assessment by the judges. The misfit data can be reviewed by the Principal Moderaotr to enable them to identify any work that is generating non-consistent results. Clicking on the link 2210 under the listed “ID” for each portfolio takes the Principal Moderator to a page showing a more detailed view of the history for that portfolio.

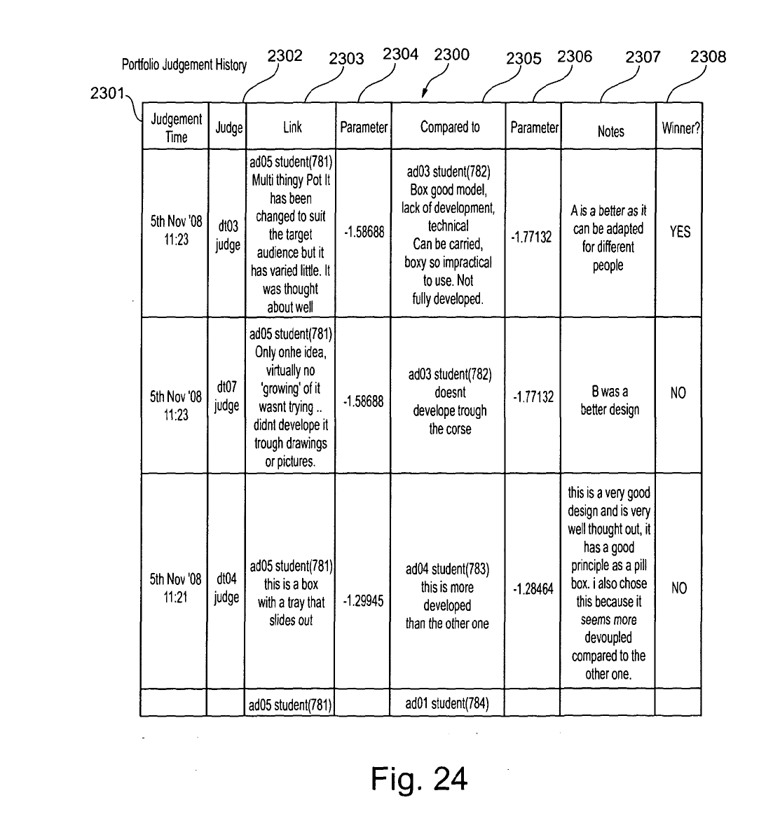

FIG. 24 shows a portfolio judgement history 2300 as viewed from an administrator's terminal 25, showing details of the portfolio and all of the portfolios it was compared to. The a portfolio judgement history 2300 displays: a “Judgement time” column 2301 displaying the time a judge spent making the particular judgement; a “Judge” column 2302 displaying the name or other identifier of the judge; a “link” column 2303 to provide a link to the portfolio statistic page; a “parameter” column 2304 showing the parameter value at the time of judging for the portfolio ; a “compared to” column 2305 displaying details of the compared portfolio; a “parameter” column 2306 showing the parameter value for the compared portfolio at the time of the judgement; a “notes” column 2307 displaying the judge's notes on the judgement; and a “Winner” column 2308 indicating if the judge judged the portfolio a winner or loser.

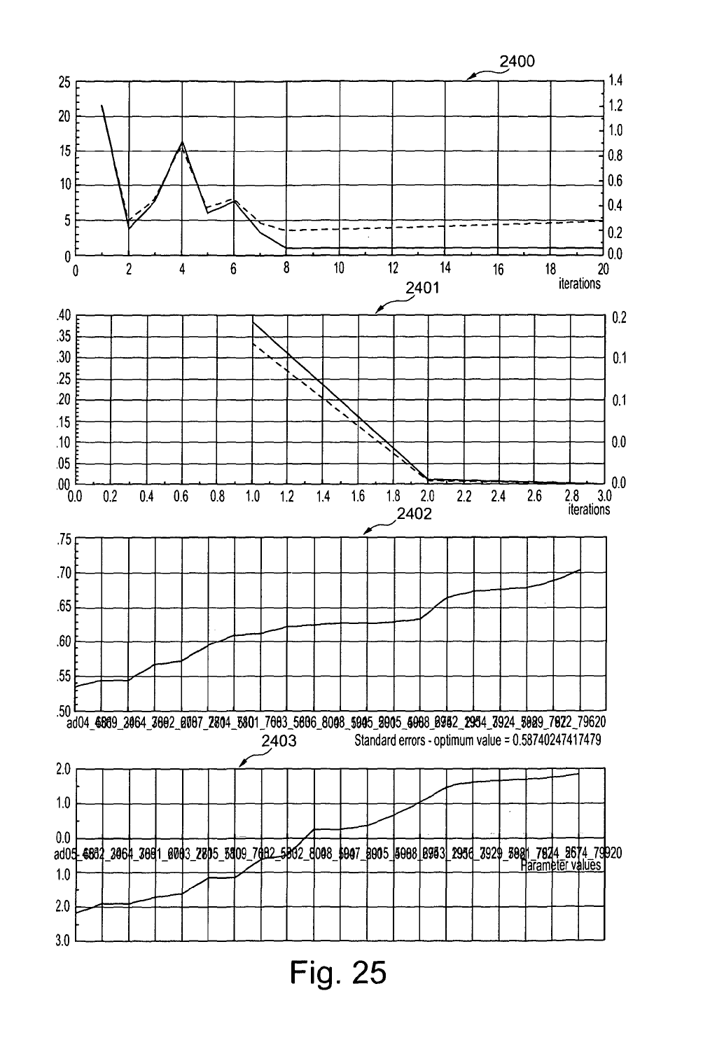

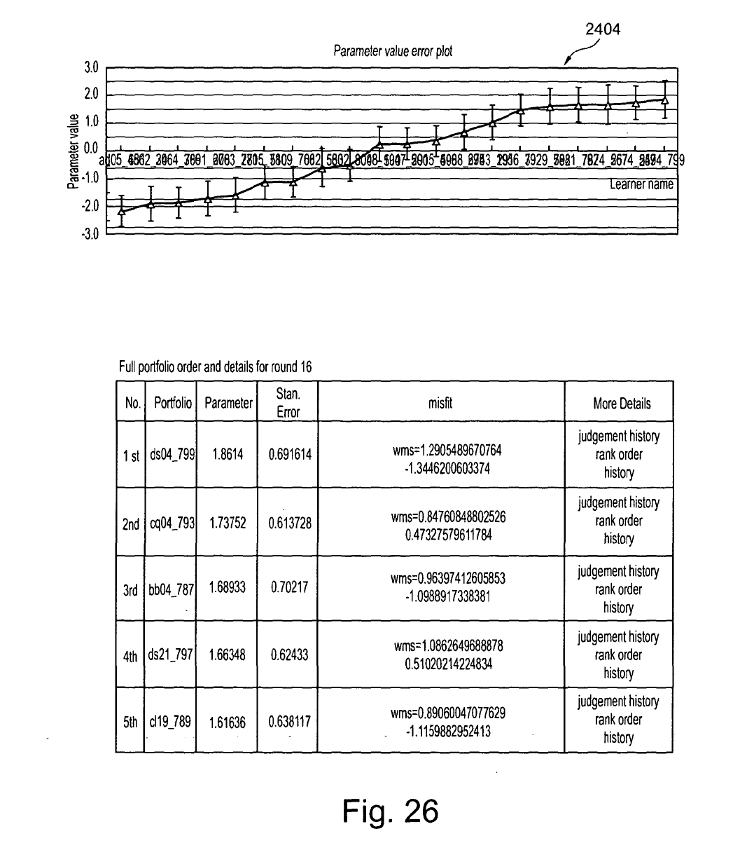

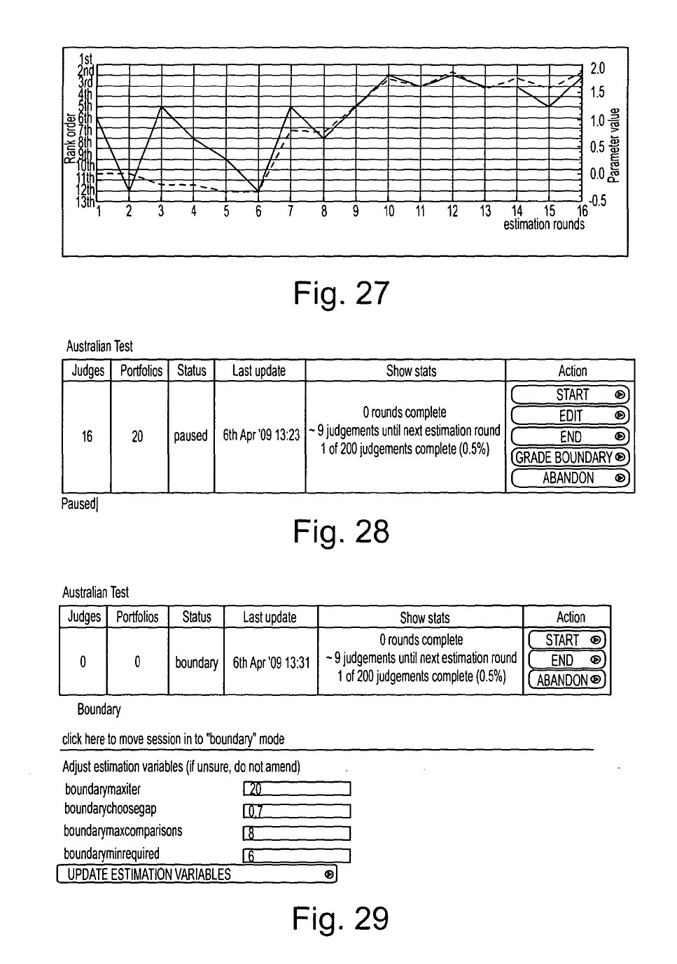

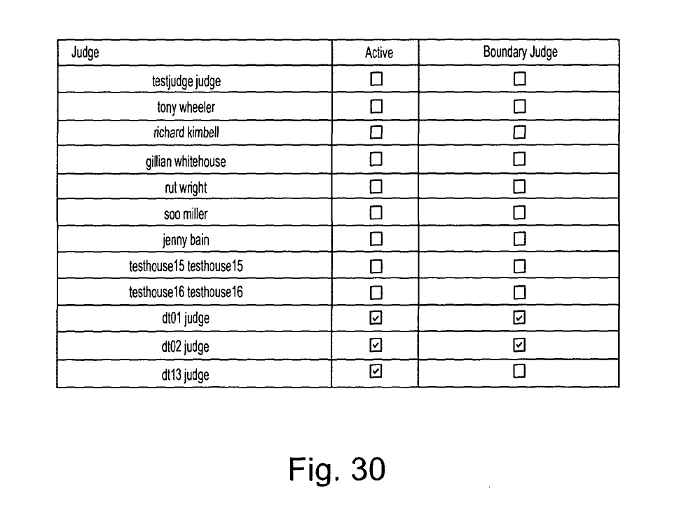

FIG. 25 shows graphical representations showing the statistical significance of the order of the portfolios as the number of rounds progresses. Graph 2400 shows details of the Rasch analysis for a given number of iterations or chapters. The lower line uses the centring figure and the upper line uses the RMS figure. As can be seen, this shows an unstable situation, as the line slopes upwardly as more iterations are performed. The first graph 2401 shows details of the estimation Rasch analysis proceeding in a more usual stable condition. Only three iterations are required to fall to a near zero condition, dropping below the threshold of 0.01. Note that for the first 6 rounds the estimation process graph will be blank as the engine 15 uses the Swiss tournament.

The second graph 2402 shows the spread of standard errors, showing that the errors are settled between 0.55 and 0.70. The standard error graph just lists the errors for each portfolio in numerical order. This graph just enables the Principal Moderator to get a quick snapshot of the range of standard errors generated during the estimation process.

The third graph 2403 shows the spread of parameter values. The parameter value graph serves a very similar function to the standard error graph above. The third graph 2403 shows the parameter values for the portfolios 7 in numerical order. It gives the Principal Moderator a quick view of the range of the values and the shape of the distribution. You would expect to see a roughly linear view from a potential minimum of −10 to a potential maximum of +10. The “optimum value” standard error shown just below the axis is just the statistical average you would expect from any sample containing this number of portfolios.

The fourth graph 2404 is a combination of the previous two graphs and shows the spread of portfolios with their parameter values and a red bar indicating the standard error for that portfolio. The following are some examples of the graph detailing the estimation process.

The final graph is a combination of the parameter and standard error views. It has the same basic shape as the parameter value graph being as it also lists the parameter values in numerical order. In this graph the standard error for each portfolio is also show in the same scale as a red error bar.

FIG. 31 shows steps in a routine for facilitating distribution of answer portfolios amongst the judges. The routine begins with setting 2501 a judge, then checking if the round is a Swiss tournament round or if the round involves carrying out a Rasch analysis and using the parameter value in the round, as shown in boxes 2502 and 2503 respectively. The next step is to set the chosen portfolio answer with a value “PORTFOLIOA” 2504, use a default constant value “GAP” 2508 of preferably 0.7 and comparing PORTFOLIOA 2504 with all of the other answer portfolios “PORTFOLIOLIST” 2505 and selecting a group by the fewest seen by the set judge. Thus us followed by another check to establish if this is a Swiss Tournament round and if so, a portfolio answer is picked at random from “MINIVIEWS”. If the round is not a Swiss Tournament round, then an “OPTIMUM” is established from the MINIVIEWS 2506 using the GAP value between each pair with the MINIVIEWS 2506 and presenting an array of the answer portfolios in ascending order for the set judge.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes.

1-28. (canceled)

29. A method for manipulating data in the assessment of an answer portfolio, the method comprising the steps of routing a multiplicity of answer portfolios to a file server, each answer portfolio assigned with an identifier, the file server having an engine running an algorithm, the algorithm sorting the multiplicity of answer portfolios into pairs of answer portfolios using the identifiers and routing each pair of answer portfolios to a defined judge's computer terminal of a multiplicity of judge's computer terminal, the algorithm comprising the steps of receiving data from the judge's computer terminal indicative of which of the answer portfolios of the pair of answer portfolios wins over the other of the pair of answer portfolios the method further comprising the step of the engine running said algorithm using said data, the algorithm comprising a Rasch analysis.

30. A method in accordance with claim 29, wherein said Rasch analysis checks each answer portfolio against all other answer portfolios of the multiplicity of answer portfolios.

31. A method in accordance with claim 29, wherein a parameter value (V) is calculated for each answer portfolio and used in the selection of pairs of portfolio answers.

32. A method in accordance with claim 31, wherein the Rasch analysis comprises the step of calculating an adjustment figure (Δᵢ) to adjust the parameter value (V) to calculate on adjusted parameter value.

33. A method in accordance with claim 32, wherein the adjustment figure (Δᵢ) is calculated using the equation:
$${Δ}_{i} = \frac{- ( {num}_{i} )}{{demon}_{i}}$$
wherein:
“numᵢ” is calculated using the equation:
$${num}_{i} = {\sum }_{j , j \neq i} {wins}_{ij} - ( {comp}_{ij} \times prob ( i , j ) )$$
“denumᵢ” is calculated using the equation:
$${denom}_{i} = {\sum }_{j , j \neq i} {comp}_{ij} \times prob ( i , j ) \times ( 1 - prob ( i , j ) )$$
“prob(i,j)” is the probability of (i) winning or losing against (j);
“winsᵢⱼ” is the number of times answer portfolio (i) won when compared to the other answer portfolio (j); and
“comp(I,j)” is the number of times answer portfolio (i) was compared to the other answer portfolio (j).

34. A method in accordance with claim 32, wherein said adjusted parameter value (Vi) is calculated by the equation:
Vᵢ=vᵢ−Δᵢ

35. A method in accordance with claim 32, wherein the algorithm centers all of the adjusted parameter values (V) about an average parameter value (⁻V).

36. A method in accordance with claim 35, wherein the Rasch analysis comprises the step of centering all of the adjusted parameter values (V) about an average parameter value (⁻V)
$$\overline{V} = \frac{{\sum }_{n = 1}^{N} {V}_{n}}{N}$$
using the equations:
wherein (N) is the number of portfolio answers in the multiplicity of portfolio answers; and
V_{centre}=Vᵢ− V̅

37. A method in accordance with claim 32, wherein the algorithm calculates a Root Mean Square (RMS) value of the adjustment figures (Δₙ) using the below equation:
$${Δ}_{rms} = \sqrt{\frac{{\sum }_{n = 1}^{N} {( {Δ}_{n} )}^{2}}{N}}$$
and the algorithm checking the Root Mean Square (RMS) value of the adjustment figure (Δ) relative to a threshold.

38. A method as claimed in claim 37, wherein the Rasch analysis stops when the Root Mean Square (RMS) value of the adjustment figure (Δ) is below said threshold.

39. A method in accordance with claim 29, further comprising the step of the engine carrying out at least three rounds of a Swiss tournament before the answer portfolio are subjected to said Rasch analysis and selecting pairs of portfolio answers based on number of wins.

40. A method as claimed in claim 39, wherein the parameter value for each of the multiplicity of portfolio answers is shown on a graph.

41. A method in accordance with claim 40, wherein a standard error is calculated for each portfolio answer and displaying the standard error on the graph.

42. A method in accordance with claim 29, wherein each portfolio answer is assigned an initial parameter value (V) calculated using the following equation:
$${V}_{i} = ( {wins}_{i} \times ( \frac{spread}{maxwins} ) ) - ( \frac{spread}{2} )$$
wherein:
“Vi” is said parameter value for answer portfolio i;
“winsᵢ” is the number of wins for the answer portfolio i;
“spread” is a fixed value for the range of the parameter values; and
“maxwins” is the largest number of wins recorded by an answer portfolio (7) of the multiplicity of answer portfolios.
and the parameter value (V) used to select pairs of portfolio answers.

43. A method in accordance claim 29, wherein the Rasch analysis comprises the step of calculating a probability of answer portfolio (i) winning or losing against answer portfolio (j).

44. A method in accordance with claim 43, wherein the probability is calculated using the equation:
$$prob ( i , j ) = \frac{exp ( {v}_{i} - {r}_{j} )}{1 + exp ( {v}_{i} - {r}_{j} )}$$
wherein:
“prob(i,j)” is the probability of (i) winning or losing against (j);
“Vi” is the parameter value of (i); and
“Vj” is the parameter value of (j).

45. A method in accordance with claim 44, wherein the engine carries out the step of
$${W}_{i} = {\sum }_{j , j \neq i} prob ( i , j ) \times ( 1 - prob ( i , j ) )$$
calculating a misfit value for each of the portfolio answers, the misfit value calculated by the equations:
$$\text{?} = {\sum }_{j , j \neq i} ( 1 - prob ( i , j ) ) \times prob ( i , j ) \times {( \frac{1 - prob ( i , j )}{\sqrt{( 1 - prob ( i , j ) ) \times prob ( \text{?} )}} )}^{2}$$
$${misfit}_{i} = \frac{{W}_{i}}{\text{?}}$$
$$\text{?} \text{indicates text missing or illegible when filed}$$

46. A method in accordance with claim 45, wherein the mis-fit value is displayed graphically.

47. A method in accordance with claim 44, wherein the engine executes a judgment algorithm to assess quality of the judges by comparing results a judges judgments with the judgments of at least a portion of judgments made by other judges.

48. A method in accordance with claim 47, wherein the judgment algorithm calculates a misfit value calculated using the following equations:
$${misfit}_{judge} = ( {WMS ( cube )}_{judge} - 1 ) \times ( ( \frac{3}{{Q}_{judge}} ) + ( \frac{{Q}_{judge}}{3} ) )$$
$${WMS ( cube )}_{judge} = \sqrt[\text{?}]{\frac{{W}_{judge}}{{W}_{z {2}_{judge}}}}$$
$${Q}_{judge} = \sqrt{\frac{( \frac{{κ}_{judge}}{{W}_{judge}} )}{{W}_{judge}}}$$
$${W}_{judge} = {\sum }_{n = 1}^{N} prob ( i , j ) \times ( 1 - prob ( i , j ) )$$
$${W}_{z {2}_{judge}} = {\sum }_{n = 1}^{N} ( 1 - prob ( i , j ) ) \times prob ( i , j ) \times {( \frac{1 - prob ( i , j )}{\sqrt{( 1 - prob ( i , j ) ) \times prob ( \text{?} )}} )}^{2}$$
$${κ}_{judge} = \text{?} ( prob ( i , j ) \times ( 1 - prob ( i , j ) ) \times ( ( prob ( i , j ) ) \text{?} + ( 1 - prob ( i , j ) ) \text{?} ) ) - ( prob ( i , j ) \times ( \text{?} \\ \text{?} \text{indicates text missing or illegible when filed}$$

49. A method in accordance with claim 29, wherein pairs of portfolio answers are selected after the Rasch analysis by selecting portfolio answers which have a parameter value difference of between 1.0 and 0.5, and preferably by 0.8 and 0.6 and most preferably by 0.7.

50. A method in accordance with claim 29, wherein each portfolio answer forms part of between five and thirty and preferably between twelve and twenty pairs of portfolio answers to be judged.

51. A method in accordance with claim 29, wherein a student's computer terminal is connected to the internet, the portfolio answer submitted and sent to the file server over the internet.

52. A method in accordance with claim 29, wherein said portfolio answer is sent to an invigilator's computer for submission to the file server.

53. A method in accordance with claim 29, wherein the multiplicity of examination answers are each prepared and sent to said file server from a student's computer terminal.

54. A method in accordance with claim 29, wherein the data is sent from the judge's computer terminals to the file server over the internet.

55. A method in accordance with claim 29, further comprises the step of transmitting forecast data to the file server, the forecast data providing information on a forecast grade for the candidate a first set of a plurality of pairs of identifiers is formulated before the first round of Swiss tournament

56. A system for manipulating data in the assessment of examination answers, the system comprising a file server, examination answers in the form of data routed from a multiplicity of computer terminals, each examination answer assigned with an identifier, the file server having an engine running an algorithm, the algorithm sorting the multiplicity of examination answers into pairs of examination answers using the identifiers and routing each pair of examination answers to a defined judge's computer terminal of a multiplicity of judge's computer terminals, the algorithm comprising the steps of receiving data from the judge's computer terminal indicating which of the examination answers of the pair of answer portfolios wins over the other of the pair of answer portfolios, the system using the data in said algorithm, the algorithm comprising a Rasch analysis.
